(19) United States
(12) Patent Application Publication
(10) Pub. No.: US 2008/0270398 A1
(43) Pub. Date: Oct. 30, 2008

(54) Product affinity engine and method

(76) Inventors: Matthew J. Landau, Arlington, MA (US); Joseph Vigneau, Newton, MA (US); Brian Collins, Allston, MA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/796,886

(22) Filed: Apr. 30, 2007

(51) Int. Cl. G06Q 30/00; G06F 17/18

(52) U.S. Cl. 707/6; 705/27

(57) ABSTRACT

The present invention relates to a computerized engine and method for using the same to determine and effect product sales to customers based on customer-driven affinities relating to the products. In some embodiments, the computerized engine includes hardware and software and uses customer or transaction data or product characteristics to calculate an output relating to the affinity. In some embodiments, the computerized engine provides an output indicative of the affinity. In some embodiments, the computerized engine is coupled to a database containing the customer or transaction data or product characteristics. The system and method can also determine a reduced affinity depending on a period of time elapsed between a pair of events being related, or as a function of the age of collected affinity data.

### TECHNICAL FIELD

The present invention relates to a computerized engine and method for using the same to determine and effect product sales to customers based on customer-driven affinities relating to the products. In some embodiments, the computerized engine includes hardware and software and uses customer or transaction data or product characteristics to calculate an output relating to the affinity, and the computerized engine provides an output indicative of the affinity.

### BACKGROUND

Electronic systems for conducting product sales to buyers have been developed and are now in wide use. The conduct of commerce over electronic networks is sometimes referred to as e-commerce, and includes an increasingly-popular segment of commerce whereby individual or institutional buyers can shop for products and services using client software coupled over a network (e.g., the Internet) and accessing specialized commerce servers and associated databases. E-commerce systems and software sometimes rely on existing client-server infrastructure, at least in part, for example World Wide Web (“Web”) browser software, which communicates with a server using accepted protocols such as the Hypertext Transfer Protocol (HTTP). A buyer or customer or consumer is typically using a computer coupled to the network and running at a client side of the network, while the seller or retailer or vendor typically employs one or more specialized e-commerce servers on hardware and software running on a server and associated components at a server side of the network. Normally, a single transaction or session is used to browse the seller's offerings, make the buyer's selections and customize the product order, as well as conduct the financial transaction to pay the seller or authorize payment from the buyer to the seller.

FIG. 1 illustrates a prior art ecommerce system 100, in which a customer 102 accesses the Internet 106 through a browser application running on a client computer such as a personal computer (“PC”) 104 in the customer's home. The customer makes a request using the HTTP protocol to connect to a Web site known to host a retail commerce page, and the request and associated responses are communicated to a server 110 protected by a firewall 108. Server 110 accesses information necessary for the conduct of the transaction through an application server 112 which is coupled to an enterprise database 114 that stores the information necessary for the conduct of the transaction. Typically, the server 110, firewall 108, application server 112, and enterprise database 114 reside at a remote site 116 operated by or for the retailer. This approach may be considered a three-tiered system, with the server 110 being a first tier of the system, the application server 112 being a second tier of the system, and the enterprise database 114 being a third tier of the system. Other components, such as additional firewalls, accounting systems and databases, etc. can be included in the simplified architecture described above as is known by those skilled in the art.

The hardware and software used for e-commerce generally provides buyers with a navigable interface for selecting and purchasing products and services (collectively “products”) as available from a product database coupled to the servers. Given the vast pool of available products now available to buyers and the proliferation of networks and products and databases providing electronic commerce opportunities, it is becoming increasingly complicated for both buyers and sellers to: compare the available products, determine which product or products are best suited for a particular buyer or class of buyers, and properly group multiple products for sale to a same buyer or class of buyers. Improving electronic commerce software and techniques in a crowded market of online retailers is especially important for sellers who operate the software with hopes of capturing more customers and creating more sales activity. In view of the ever-increasing options at the fingertips of today's buyers, it is useful for online retailers to use appropriate hardware and software to effect electronic sales transactions and marketing campaigns to promote the same.

One approach accepted by some or all retailers is that buyers benefit from customized product promotion and presentation to the buyers. That is, a buyer is presumably more inclined to make a purchase if presented with products that the buyer is interested in. A buyer is less inclined to make a purchase if presented with selections that the buyer is not interested in, does not like, are incorrectly priced, or are incorrectly grouped. The selection of the information that is best suited for a particular buyer or group of buyers is of some concern to retailers and marketing campaign designers. The strategy of determining the appropriate presentation to a buyer is sometimes referred to a “personalization” in e-commerce.

Personalization in electronic marketing and sales is not a new concept. Personalization in the context of e-commerce sometimes includes determination of the identity of an individual visitor to an electronic store, and based on the identification of the visitor, the e-commerce server tailors the actual presentation of an electronic storefront to that visitor. That is, once identified, a visitor or potential buyer is presented with a virtual storefront designed with that visitor in mind, and may differ from the exact storefront the server presents to another visitor.

Determining the individual identity of a potential buyer or visitor is sometimes done by requesting personal information from the visitor, e.g. a user name or account number, which is compared to a stored database to identify the visitor and best determine his or her preferences. The preferences themselves are usually also kept in the database and associated with the visitor's personal information. It is common for the preferences to rely on prior purchasing activity by that individual visitor and logging or storing the prior purchasing activity of the visitor. Each purchasing transaction is added to the database, and presumably can improve the effectiveness and accuracy of the seller's personalization process.

Another way to identify a visitor to an e-commerce retail site is through “cookies” installed on the client machine of the visitor, e.g. in a Web browser program's data, that can identify the visitor to the e-commerce server without explicitly requiring the visitor to enter personal information. In each case, the seller's e-commerce system includes programs that use the customer data and the product database to create an appealing shopping experience for the customer to presumably better serve the customer and maximize sales.

Personalization techniques can also be directed to a class or group or type of buyer instead of being directed to a specific identified individual. For example, and rather generically, an e-commerce site may target potential buyers by their gender (some sites being more targeted towards males, while other sites are more targeted towards females). Classes of potential buyers can also be created by age group (some sites targeting young buyers, while others target older buyers). These groupings of potential buyers can be further refined, for example to include: young aged, middle aged, and elderly as three groupings by age, and so on. Also, groupings incorporating more than one characteristic of the potential buyer can be developed, such as: young female, young male, old female, and old male. This approach to dissecting the pool of customers into logical groups is sometimes referred to as “segmentation,” and can be applied as well to the pool of available products, so that a given product segment can be best matched to a corresponding customer segment. The process of grouping a customer with other customers deemed to be similar to this customer and then attempting to predict this customer's future purchasing needs is referred to as “psychographic profiling.” Once profiled, e-commerce engines attempt to analyze the group's profile and purchasing patterns (“collective filtering”) to predict future interests of a member of the group with the apparent (past) interests of the other members of the group. Online commerce sites such as Amazon.com and ebay.com and others use these techniques.

Today, a number of e-commerce solutions attempt to improve online shopping results for buyers and retailers by making purchase recommendations to customers based on known data and algorithms for customizing the e-commerce experience over the Internet. Sites proclaiming that persons who purchased one product were also interested in or did purchase another product can be found. If a user is identified, whether by entering personal information or through a cookie on the user's computer, online retail storefronts are also known to present the user with a set of products believed to be of interest to that user, sometimes even before the user indicates what he or she is looking for in the present transaction.

A need exists for better serving both buyers and sellers in e-commerce. This includes making e-commerce transactions easier for buyers looking for a product or group of products, and enhancing the transactional experience for the buyers. A need also exists for improving the efficiency and effectiveness of electronic commerce sites offering products to buyers, and in improving the way sellers can determine what and how to present their available products to potential buyers.

### SUMMARY

Some embodiments of the present disclosure and inventions are directed to, inter alia, a system for providing purchasing recommendations to a customer, including a customer interface for sending and receiving information to and from said customer; a storage medium for storing data relating to said products; a processor for processing data relating to said customer and said products; said processor determining an affinity between at least one product and another product group wherein said product group comprises at least one other product.

Other embodiments are directed to a method for providing purchase recommendations to a customer, including receiving information from said customer through a customer interface; determining a first affinity score corresponding to said received information and information stored on a storage medium containing product data; determining whether to make a purchase recommendation to the customer based on the first affinity score; if said affinity score does not meet a preset threshold condition, determining a second affinity score corresponding to said received information and information stored on the storage medium.

Yet other embodiments are directed to a computer-readable medium accessible to an online retailing system, including computer-readable instructions enabling the receipt of customer information from a customer information interface; computer-readable instructions enabling the access of stored product information; computer-readable instructions enabling an affinity processor to take said customer information and said stored product information and determine an output corresponding to an affinity relating to one or more of said stored product information; and computer-readable instructions enabling said online retailing system to make a purchase recommendation to said customer.

### BRIEF DESCRIPTION OF THE DRAWINGS

The present invention can be better illustrated and understood in view of the accompanying drawings, in which:

FIG. 1 illustrates an exemplary prior art e-commerce system;

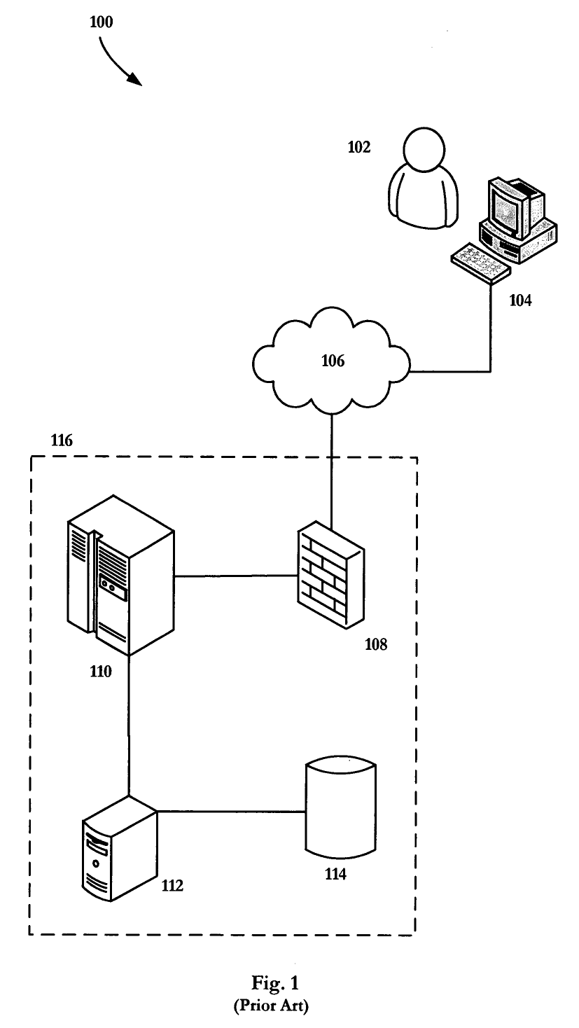

FIG. 2 illustrates a conceptual example of the present system configured with modular components;

FIG. 3 illustrates an exemplary e-commerce server system including a Web server and affinity engine according to an embodiment of the present invention;

FIG. 4 illustrates an exemplary segmentation of a number of products and customers;

FIG. 5 illustrates an exemplary scenario for presenting an ordered list of recommendations;

FIG. 6 illustrates a conceptual arrangement of a product tree;

FIG. 7 illustrates an exemplary e-commerce system with affinity engine and server according to an embodiment of the present invention;

FIG. 8 illustrates a possible sequence of steps for providing pre-lookup and post-lookup recommendations;

FIG. 9 illustrates an exemplary sequence of steps for determining a best or acceptable affinity using products and segments;

FIG. 10 illustrates an exemplary affinity engine with statistical and configurator modules according to an embodiment of the present invention;

FIG. 11 illustrates an exemplary block diagram of a closed-loop process according to the present system and methods;

FIG. 12 illustrates an exemplary time windowing of data used by the present system and methods; and

FIG. 13 illustrates an exemplary way of decreasing the calculated affinities based on a length of time that elapses between two items being related to one another in the affinity e-commerce engine or an age of the collected data in a data warehouse.

### DETAILED DESCRIPTION

A system for facilitating electronic commerce (“e-commerce”) transactions is described below. The system can be provided as part of a system for conducting purchase and sale of products for value, such as an online transaction for the sale of a tangible product or service (generally “products”) in exchange for a determined monetary sum.

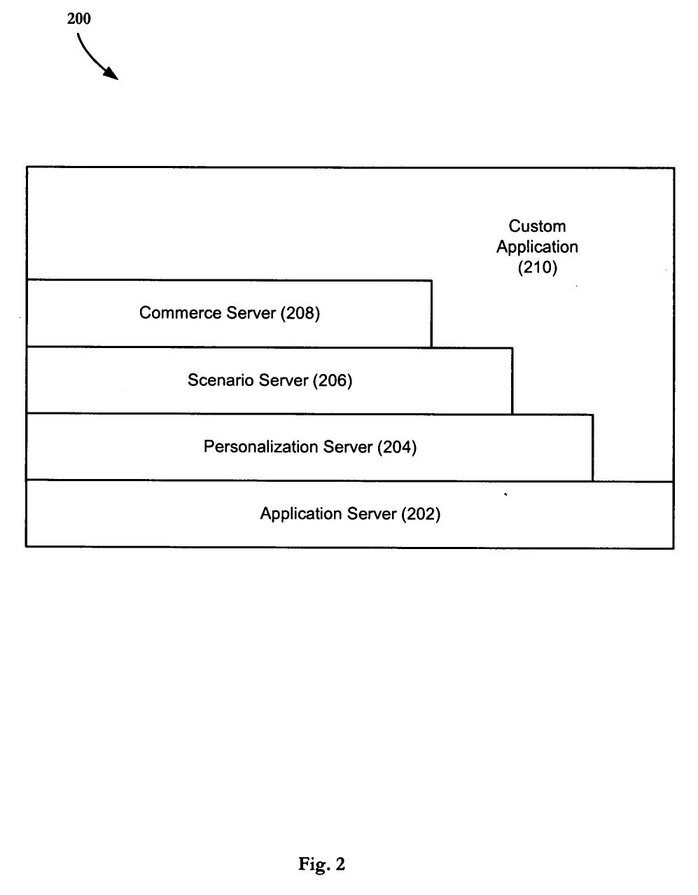

Various features of the present system and methods can be adapted for use with or within the e-commerce products available from Art Technology Group, Inc. (“ATG”) of Cambridge, Mass. By way of example, and referring to FIG. 2, the present system and methods are adaptable for implementation with an application server 202, a personalization server 204, a scenario server 206, and a commerce server 208, all of which are available as components of an overall e-commerce system 200, and on with which custom application software 210 may be integrated and run to provide an e-commerce solution for online retailers, vendors, and service providers.

In use, the present systems can be designed and operated at least in part to rely on existing computing technology such as servers and clients sold by a number of vendors, as well as operating systems and servers and database access tools available from a number of sources. In fact, in some or all embodiments, the present system and methods can be implemented in a “modular” fashion as a set of “tools” that are made available to developers and designers with which they design the particular system according to their needs and budgets and other constraints. For example, where the present system uses a personalization engine or a search engine or a database engine, these components may be available from the provider of the present affinity engine, or may be provided by another entity for use with the present affinity engine. Accordingly, a user of the present system and methods may develop his or her own components using hardware and software in order to customize the operation of the present system and obtain the most suitable results. The software used to develop the present system and methods can be of almost any nature, but specific implementations using the C++ and the Java programming languages are within the scope of the present discussion.

The present system and methods comprehend implementations using a stand-alone set of components that are co-located, as well as installations that rely on a distributed set of components that may be logically connected but physically separated from one another. The packaging and distribution and licensing of the present system and components thereof will be understood by those skilled in the art upon review of the present disclosure, including its drawings and claims.

In operation, the present system and methods enable online affinity-based promotion of products and segments of products to target customers or segments of customers for the benefit of the customer, segment of customers, and generally to the benefit of the retailer operating the e-commerce site. Prior knowledge of an individual customer's buying patterns or the buying patterns of similar customers, or the buying patterns of all customers are used to enhance the customer's online shopping experience and more effectively and efficiently provide the customer with products that the customer needs or wants from among the myriad products available for sale.

Embodiments of the invention are further concerned with systems for and ways of configuring the information provided to prospective buyers of products from among a collection of a plurality of products available for sale. The present systems and methods allow configuration and construction of e-commerce sites that are coupled to logic to automatically customize and arrange the content of the site to better suit a specific site visitor or segment of visitors.

The system enters (sometimes referred to as “pushing”) relevant data into a data storage device, e.g. a computer hard disk or an external database or magnetic or optical storage device. Arrays or networks of storage systems can be implemented to scale the system to accommodate significant volumes of data traffic representing large numbers of storage and access operations per unit time as known to those skilled in the art, with the data being stored in data warehouses. The stored data can subsequently be accessed, and is used in the future determination of responses to inquiries by a specific customer or by inquiries from a segment of such customers. In some embodiments, the segmentation of the customer pool or the product pool encourages effective and efficient shopping results. In some embodiments, the system can operate to further advantage by collecting more data or by exchanging (e.g., receiving) more data about a customer, a segment or customers, a product, or a segment of products.

Purchasing needs, predilections, tendencies, and other patterns of e-commerce behavior generally referred to herein as “affinity” can be determined with the present system and methods, and a specialized apparatus or logic engine, embodied in computer hardware and other components, can be configured accordingly to seek, determine and implement a process for affinity-based selling, marketing, shopping, browsing, buying, and online affinity-driven transactions. Affinity-based shopping services can be provided to online customers using an affinity engine as disclosed herein which improves or optimizes the online shopping experience for buyers and results in better results (e.g., sales) for online retailers.

Physically, the apparatus may include or may be coupled to a database. The apparatus may further include or be coupled to a server that is adapted for communication with a client over a network such as the Internet. Collectively, these components and others are implemented in a system of the present invention, including electronic hardware, computers, including data processors, servers, clients, browsers, multimedia players, storage devices, communication devices, input and output devices, credit, debit, and currency exchange devices, load monitors, security systems and firewalls, and generally software and computer instructions suited for execution on a processor of the system to carry out processes and steps of the present invention.

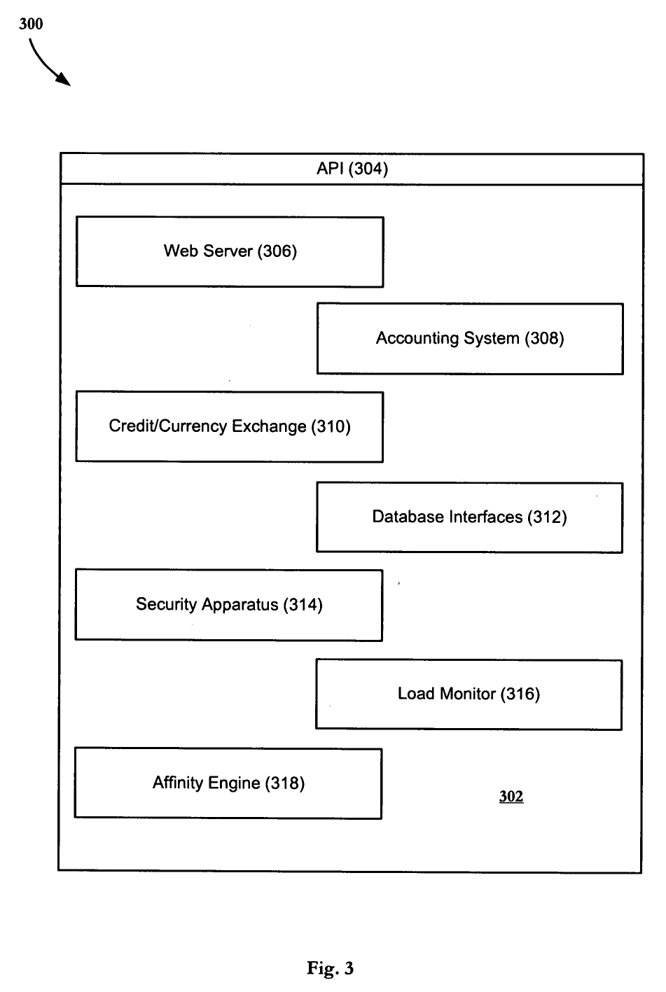

FIG. 3 conceptually illustrates a system 300 as described above, including one or more processor-equipped machines 302, such as one or more server computers, on which the present invention may be implemented. Servers 302 and their constituent components may be implemented in any way suitable for the application at hand, and may be integrated into one or more physical machines at one or more physical locations, or may be distributed into a plurality of physical machines which may be at more than one physical location.

One or more application programming interface (“API”) 304 is provided to exchange data between the various components of the system according to accepted protocols, which may include protocols for communication with external systems over a network and protocols for communicating with other applications, application servers, and database systems. A Web server 306 is the primary system for communicating with clients over a network such as the Internet using a protocol such as HTTP or a secure protocol as needed. An accounting system or server 308 handles customer account information and billing. A credit or currency exchange 310 is responsible for taking credit card information or other methods of payment, and may be a secure service provided to the system for the purpose of payment for goods delivered. The system also includes a database interface 312 for placing data into and retrieving data from an enterprise database infrastructure. A security apparatus 314 provides security against unauthorized access to data and against attempts to tamper with the accounting and credit/currency exchange. Load monitor 316 monitors the usage load on the system and distributes the load in a way that balances the resources required by each of the system components, such as Web server(s) 306 to avoid or minimize overloading and improve performance. Affinity engine 318 provides the application intelligence to optimize the online retail presence of the retailer and present the best online storefront information and recommendations to customers. Affinity engine 318 also performs other data collection, processing, and reporting functions described in more detail below, mainly relating to determination of affinity between products, customers, and segments of products and customers. Affinity engine 318 relies on information stored in databases and accessible through database interfaces 312, and provides an output to Web server 306.

The affinity engine 318 can determine appropriate responses and recommendations based on an accumulated shopping behavior of many or all of a site's customers. Specifically, the affinity engine can perform these tasks based on the shopping behavior of a plurality or of all of a certain segment of customers. For example, the affinity engine's response to a young shopper's activity and its recommendations to the young shopper may be the result of analysis of the shopping behavior of other young shoppers, and even excluding the shopping behavior of older shoppers.

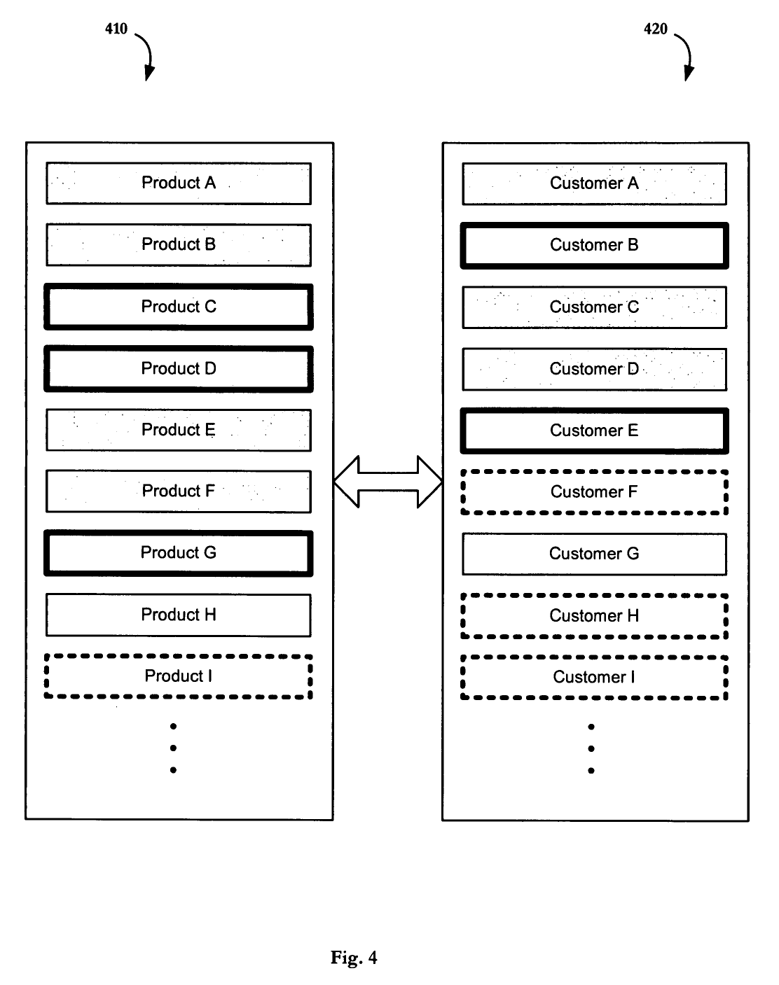

FIG. 4 illustrates the segmentation of products and customers into product segments and customer segments. Certain customers grouped into segments can be generally observed to have an affinity towards certain corresponding product segments (e.g., young customers are found to have an affinity to pop entertainment product segments). The correspondence between the segments of customers and products and between a product and another (indicating a correlation of a feature of a product with another feature of another product that result in likely common sale results) are not necessarily one-to-one. Products 410 include a catalog of products (Product A, Product B, . . . ). The products 410 have been determined to fall into several categories, types or segments, where for example Products A, B, E and F are in a first segment; Products C, D and G are in a second segment; Product H is in a third segment; and Product I is in a fourth segment. Similarly, customers 420 can be grouped into segments, with Customers A, C and D being in a first segment; Customers B and E being in a second segment; Customers F, H and I being in a third segment; and Customer G being in a fourth segment. The segmentation of products and customers can be done in any (or a plurality) of ways as suits a particular purpose at hand.

As far as the causality of the affinity engine's recommendations, it can be adapted to wait until some detectable pattern of shopping or browsing is determined. Therefore, for example, a shopper may begin using the site in its generic storefront presentation, and only after the shopper has performed one or more acts of browsing or inquiry will the affinity engine modify its presentation to the shopper accordingly. For example, a shopper entering a home improvement products retailer's online store may initially be presented with the same virtual storefront as all other arriving customers. However, if the shopper selects a link to (or enters a search for) plumbing supplies, then the server serving the customer will present a plumbing-specific storefront to the customer, or the storefront will be biased towards plumbing supplies and products for the benefit of this customer. This approach can be applied to customers who are known before they begin interacting with the site, e.g. those arriving with a cookie or entering their personal identification information. In addition, this approach can be applied to site visitors who do not, or have not yet, identified themselves to the server. This is because the visitor is supplying some information to the server by interacting with the server sufficient to form a better customized shopping experience, even if the visitor is not yet identified. The fact is that this visitor is interested in plumbing products, and that is enough to start modifying the site's presentation for the customer.

Of course, a customer who is previously known to the server, and who identifies himself or herself to the server, may be further served in other ways described herein. In the example above, a customer who identifies himself or herself to the server may be previously known to generally purchase high-end (expensive) lines of products. In which case, the site can tailor the presentation to the customer to not only be plumbing-oriented, but further to be specifically high-end plumbing-oriented or biased towards the better and more expensive product lines. In other words, the system can adapt its recommendations and output to a customer's purchase history or to the purchase history of all customers, especially those with some common characteristic with the customer. Note that sometimes in conducting a transaction (e.g., a purchase) a customer may move from a first segment of customers to another (e.g., moves from a “first time buyer” customer to a “returning customer). In this case, the system can consider the customer under the segment he or she fell into prior to the recent transaction for the purposes of rules requiring customer segment as an input. This is of course a consideration in designing the system, and not a requirement that limits the present discussion or scope of the system and methods given by way of example herein. Customer segments are sometimes referred to as “persona.”

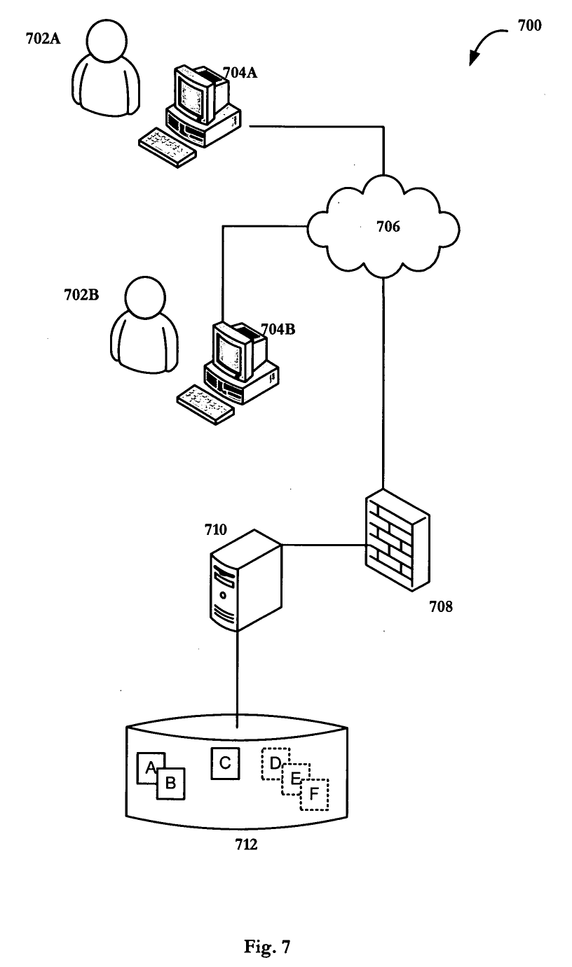

FIG. 7 illustrates a representative e-commerce system 700 according to the present disclosure. An affinity engine resides along with a server at 710 which is coupled to the Internet 706 through firewall 708. The affinity server and associated logic and processing apparatus are coupled to a database 712 that includes a plurality of data representative of a plurality of products available for sale. Customers 702A and 702B access the retail site hosted on server 710 with their respective client applications at 704A and 704B. A load balancer can be employed as discussed previously for distributing the server load in the event of a large number of customers 702. The affinity engine determines suitable affinities for each of the customers 702A and 702B, and for example, provides information and recommendations to the individual customers. The recommendations can include an ordered and scored list of products or product segments. The products can be organized into appropriate product segments as shown with products A and B making up a first product segment, product C making up a second product segment, and products D, E and F making up a third. Data relating to customer selections, browsing and purchasing is passed back to the database system for sorting, analyzing and updating future affinity engine decisions.

The affinity engine system and present methods are capable of “product purchase relationship” analysis. The system analyzes order data for both anonymous and registered customers to derive relationships between products purchased by the same customer. The results of this analysis give merchants insight into which products were purchased by the same shoppers, e.g., customers who purchased product A also purchased product B, either in the same order or in separate orders over the time period being analyzed. This analysis is performed both globally, analyzing all orders, and on a persona by persona basis, analyzing the orders placed by customers belonging to a particular persona.

Behavior across product segments and persona groups can aid product placement and recommendation and cross-selling. This data tracking can be performed globally across all personas or locally for a given persona. For example, the following information might be tracked for a certain product, called Product A:
Global: Product L, Product C, Product K
Persona 2: Product C, Product L, Product B
Persona 3: Product L, Product G, Product C
Persona 5: Product L, Product C, Product N
Persona 6: Product C, Product G, Product N

This example would indicate that across all shoppers, customers who purchased Product A most often also purchased product L and next most often purchased Product C. Shoppers in Persona 6 who purchased Product A, however, most often purchased Product C and next most often purchased Product G.

The affinity engine system and present methods are also capable of “segment purchase relationship” analysis. The system can be configured to analyze order data for registered customers to derive relationships between product categories from which products were purchased by the same customer. For example, customers who purchased products from category A also purchased products from category B, either in the same order or in separate orders over the time period being analyzed. Again, this analysis is performed both globally, analyzing all orders, and on a persona by persona basis, analyzing the orders placed by customers belonging to a particular persona.

In addition, in other embodiments, the affinity engine system and present methods are capable of “product browse to purchase relationships.” The system analyzes order and site behavior data for registered customers to derive relationships between products which were viewed (browsed) and those purchased by the same customer. For example, customers who browsed product A purchased product B. Browsing to purchase relationships can occur either within in the same session or in separate sessions (browse in one session and purchase later).

Yet other embodiments are provided with the ability to perform “product browse-browse relationships.” The system analyzes site behavior data for registered customers to derive relationships between products which were viewed (browsed) by the same customer. For example, customers who browsed product A also browsed product B. Merchants specify whether all browse-relationships are valid, or whether only to consider them when browsing of both products occurred in the same session. This analysis is performed both globally (analyze all site behavior) and on a persona by persona basis (analyze site behavior for customers belonging to a particular persona).

For a product category being analyzed, the system tracks the top related product segments both globally and for the personas which made a purchase from that product catalog. Purchase of any SKUs related to a product in that segment constitutes a purchase from that segment. Relationships are ranked according to how many customers purchased from both. If more category relationships are identified than can be tracked (either globally or for a particular persona), priority is given to the most recent purchases from the related category, then to the average sale price for the products purchased from the related category, and so on.

Tracked relationships are stored as attributes of the segment, and merchants configure how many category relationships are tracked. For example, three global relationships can be tracked as well as three relationships for each relevant persona.

Data storage and access in the present context can be performed in numerous ways, some of which are described herein for the sake of illustration. However, putting data into, and extracting data from a database for use by an e-commerce server or connected application servers is employed in many or all embodiments of the present system. In some embodiments, the data is housed and used in a query-optimized format, which is easy to use in report generation for the purpose of commerce reporting. Using logic to better design retail web sites for the benefit of customers and sellers is another feature of many or all embodiments of the present system. Artificial intelligence techniques and underlying programming sequences and instructions allows further refinement and progressive optimization of a system as described herein.

The present system and methods can benefit a number of parties, including retail marketing executive business users whose responsibilities include making decisions such as business planning, tracking inventory movement, and product marketing. One feature of the present affinity-based e-commerce system is that it can be designed and programmed to operate in the background rather than in a business interface so that a business user does not have to control the actual recommendations made by the engine. In some embodiments, a page developer authors the code underlying the pages served to clients so that the underlying code determines the product and category recommendations made to the business user. The page developer can use the affinity engine in developing e-commerce page code with tools such as the Java language, or other commercial and open source products. In some embodiments, the affinity engine includes pre-developed code for preparing e-commerce pages and is provided by the maker of the affinity engine products. In other embodiments, the basic tools for creating a custom affinity engine and related logic are provided for internal or outsource developer use.

The above approach relieves the executive business user from needing to analyze and determine themselves what specific product promotions to offer, cross-selling packages, customer recommendations, and other low-level decisions regarding product positioning. The executive business user can thereby rely on the automated or semi-automated affinity engine hereof to generate these types of low-level marketing and positioning decisions while the executive business user focuses on making high-level business decisions and approval of the overall process, for example to focus on sales trend analysis, honing key product positioning, etc.

In making affinity-based decisions and outputs as described herein, a developer or manager would sometimes like to understand the relative “goodness” or quantitative value of an affinity as determined between customers, products, or segments of the same. Therefore, the present system and methods can provide an output indicative of a quantitative goodness of an affinity that can guide the final decision as to product placement and marketing and cross-selling choices.

Affinity as determined by the present affinity engine and associated components can be calculated for several scenarios: for example, product-to-product affinity, product-to-segment affinity, segment-to-segment affinity. Within each of these scenarios, the affinities can be quantitatively compared to determine a better or best affinity and include price-based affinities, brand-based affinities, and other attribute-based affinities that are specifically disclosed herein or will be appreciated by those skilled in the art. The quantitative comparison of one affinity with another is a relative determination in some embodiments rather than an absolute value. A “reference pair” can be selected as a control or base affinity pair with which other pairs can be quantitatively compared.

Product-to-product affinity (or “product affinity”) tracks and quantifies the tendency or affinity of a customer who investigates or purchases a first product to investigate or purchase a second product. Present systems merely create ad-hoc collections of data relating to sales of products and associate the sale numbers of a first product with the sale numbers of a second product without determining an underlying affinity between the products, their segments, and the other factors that more realistically indicate future buying tendencies of a buyer or segment of buyers. In the present system and methods, the affinity engine is designed to permit various controls on the types of recommendations that are made to customers. For example, a product-to-product affinity calculation can allow a merchant to calculate product-to-product affinity for a product over a period of time (e.g., over the last year). Also, the affinity engine can specify cross-selling recommendations that are drawn only from a segment of products relating to a first product of interest. In addition, the affinity engine can limit the cross-sell recommendations to a subset of products with similar or lower price points as the product of interest. For example is a shirt is being sold as a product of interest, only similarly-priced trousers may be recommended, but in an illustrative instance, a more expensive jacket and matching belt might be included in the recommendation. Note that a merchandising user interface is not required in all or any embodiments to enable this behavior, but rather, the affinity engine can perform these types of determinations and generate the appropriate outputs in the background by virtue of its design and logic.

One present embodiment provides a merchandiser with a list of top products for a particular segment. A threshold for measuring the goodness of an affinity pair within a segment can be used to select certain top products for presentation to a merchandiser or a customer. An affinity goodness factor can be determined that permits ranking of products within a category or segment. This permits selection of best products for a specific marketing or sales placement and determination of the appropriate cross-selling placements. In addition, the affinity engine can generate an output and rank the affinities of various pairings to predict the likelihood of conversion of browsing to buying.

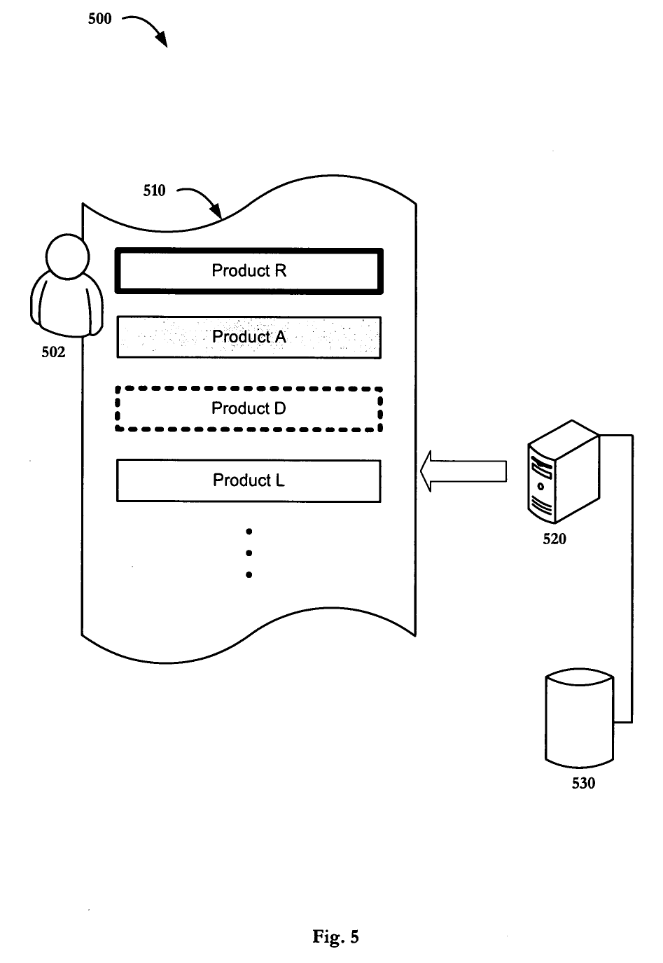

FIG. 5 illustrates a system 500 for presenting product recommendations to a customer 502 according to the present invention. An affinity engine 520, implemented in a server product is coupled to a database 530 containing the data required to generate favorable product recommendations and cross-sell suggestions to customer 502. A user interface 510 available to customer 502 presents customer 502 with an ordered list of products determined to most suit the needs or interests of customer 502. The ordering of Product R, Product A, Product D, then Product L, etc. can be arranged visually on a Web page of the user interface 510 or client application. The same system can be used to collect the decision (click, purchase, etc.) of customer 502 for inclusion into database 530.

One type of affinity is a customer “price affinity” which is a customer's tendency to purchase products from a category within a certain price range. In order to improve the efficiency of the process of online retailing, the affinity engine assigns each product to a price band (e.g., low, medium, and high) and then recommends to the customer products falling within their apparent preferred price band. In some embodiments, a list of recommended products is presented that is ordered in an ordering reflecting the price affinity to a buyer in that segment. In other embodiments, a price sensitivity threshold for a customer or segment of customers is determined, and products recommended to the customer are limited to those falling within the price sensitivity threshold. Rules relating to price affinity calculations and associated outputs of the affinity engine can be developed and incorporated into the workings of the affinity-based e-commerce systems and methods herein. The system can monitor, store and analyze purchase behavior that includes a product SKU number and SKU price, a maximum product item price, its average selling price, and a price standard deviation. The standard deviation can be set to be used only if a number of data points (e.g., greater than 10) have been collected for statistical reliability. In some embodiments, the affinity engine keeps track of the price of buyers' purchases relative to other items within the same product segment.

Consumers may expect discounts or price incentives of a certain magnitude (e.g., 40%), and may be desensitized to smaller discounts (e.g., 10%). In this case, a merchandiser needs to be able to program the affinity engine or to provide data to the affinity engine relating to discounts of certain products that would meet a minimum threshold for motivating a customer to make a buying decision. This threshold is generally different for different individuals and segments of individuals, and can also depend on the type of product in question. Since purchasing activity is rather heavily influenced by price point, and since the Internet today provides such a large field for comparison on the basis of price with considerable ease, merchants may include special features in the operational controls of their sites to be able to adjust the relative price points of their products as needed to remain competitive.

In some embodiments, product pricing can be segmented into bands, with successively higher priced products occupying correspondingly higher bands of a discrete pricing hierarchy. The affinity engine can be sensitive to the disposition and budget of customers and make recommendations for products that fall within a range (e.g., 20%) of the average or mean or typically priced product the customer has historically investigated or purchased. Furthermore, if a search for a type of product returns more than one such product (e.g., a customer searched for “microwave ovens”) then the result most closely corresponding to the customer's previous buying pattern is returned, or returned first on the Web page presented to the customer. By the same token, the affinity engine can be configured to “up-sell” or “upgrade” the customer, to entice the customer to buy the next higher priced product above the customer's traditional price point.

Another type of affinity is “brand affinity” (which can be generalized to other attributes of a product—or “attribute affinity”). Attributes are more general than the brand, and include color, country of origin, construction material, and other attributes of a product. If a customer is known to frequently buy a given brand of products, then the online retailer using the present affinity engine can place advertisements, determine recommendations, and generate cross-selling opportunities based on this affinity. So for example, when the customer returns to the site, the site can present the customer with one or more popular choices from this brand as an invitation to the customer to buy more products from the site. Rules relating to brand—(or more generally, attribute—) affinity calculations and associated outputs of the affinity engine can be developed and incorporated into the workings of the affinity-based e-commerce systems and methods herein. In some respects, this affinity can promote products based on an individual's product affinity, and accordingly, a product “slot” on the retailer's storefront can be allocated to this product brand.

The rules-based behavior incorporated into (but not limiting) the operation of the affinity engine can include phrase-based behavior and filtering. For example, a customer who is a bargain-hunter (likes to buy low cost items) may be more inclined to recommendations for “sale” or “clearance” items as identified by data in the database, while a fashionable customer who is not very concerned with cost might be more likely to select a “quality” product. These rules can be carried out automatically by the affinity engine in the form of a processor capable of executing stored logical instructions operating on data provided to the affinity engine, or data included within the affinity engine. In addition, or alternatively, the operation and setup of the affinity engine can be guided or controlled by a human operator or another piece of software or hardware adapted for this purpose.

The “conversion rate” of a product is a measure of how well the product is converted from a product recommendation to a purchased product. In some embodiments, products with the highest conversion rates among some or all past customers are presented as cross-sell recommendations at the checkout screen during the final steps of making an online purchase. Accordingly, a merchant may place cross-sell recommendations on a shopping checkout page based on how high the products' conversion rates have been, for example, placing the products with the highest conversion rates. Affinity calculations may take into account the conversion rate of a product as a measure of its desirability or affinity in some related context. Therefore, conversion rate is another datum that can be tracked and stored in the database used by the affinity engine.

Several of the techniques involved in determining affinities consider the number of units of a product sold. Product purchase count includes the SKUs for a given product. For example, if a customer purchased three different SKUs related to a product, that equates to three purchases of the product. Multiple SKUs and SKU quantity within an order count towards the computed product totals. For example, if an order contains 2 of SKU “a” and 3 of SKU “b” and both SKU “a” and SKU “b” are related to the same product, then that order represents 5 purchases of the product.

Products can be organized logically into a product “tree” with branches of the tree being associated with products within a category or segment of products belonging to that branch. Affinity can be determined between two products within a same product category or segment of products. However, affinities can also be found and determined between a product in a first product category and products in a second (different) product category. This can be useful to retailers attempting to make recommendations to customers and who find that a certain product a customer is interested in does not have very high affinities to other products in its category. The affinity engine can then traverse the product tree to locate relatively higher affinities with products in other branches of the product tree.

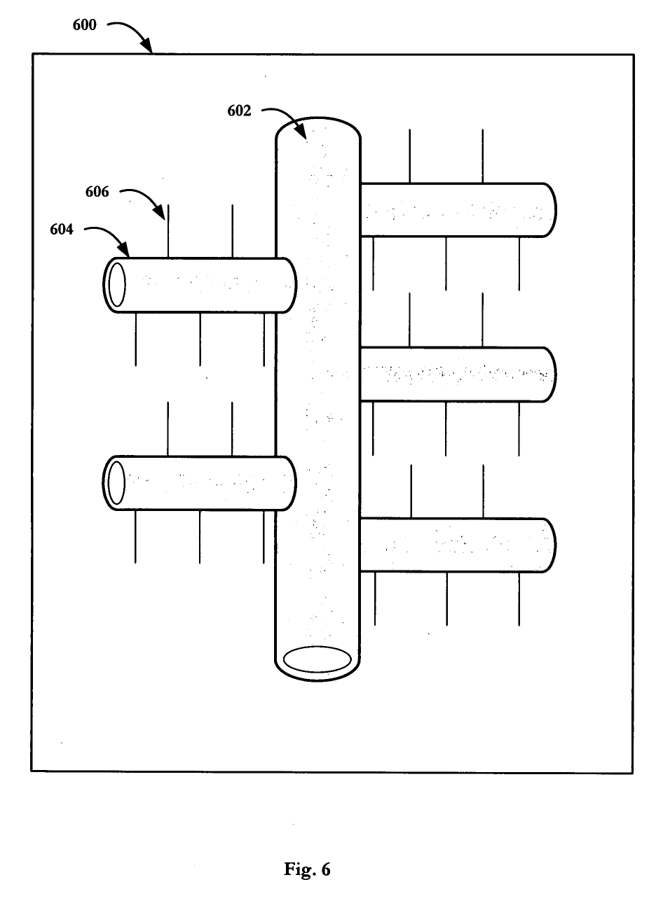

FIG. 6 illustrates schematically a hierarchical product tree represented and stored in a database 600. A first primary segment or category of products 602 is depicted as including further branching 604 and 606 which further represent product segmentation into subsets of products characterized in a way to support the present affinity-based e-commerce system and methods. It should be appreciated that segmentation for one purpose and in a given context does not preclude a product from being included in another, different, segmentation scheme. That is, the product segmentations are not necessarily exclusive. So for example a chair might be represented in a “household” segment in one representation, and simultaneously be segmented into “adult interest,” “high cost,” and “home products” segments in other representations.

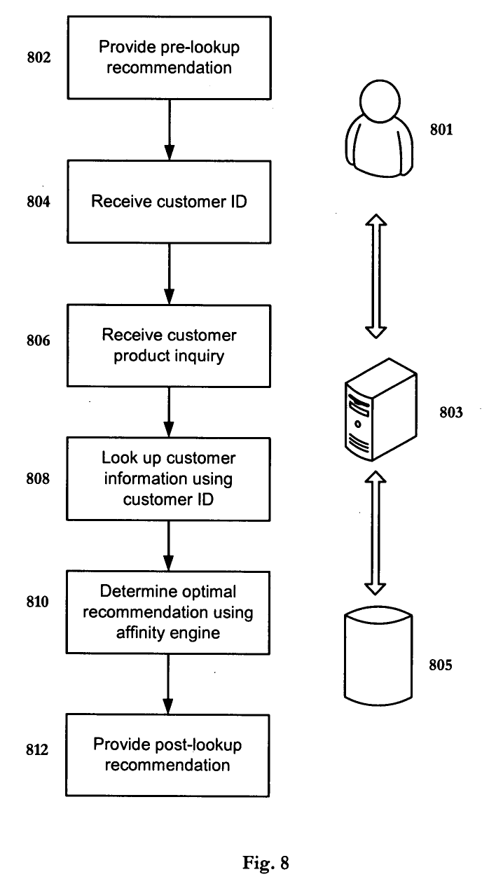

FIG. 8 illustrates a sequence of steps described above that guide the affinity-based e-commerce operations on the affinity server. User 801 interacts with server, including affinity engine 803, which accesses database 805 as described previously. At step 802, and upon initial contact with the e-commerce site, user 801 who is still unidentified to server 803 is provided with pre-lookup information and recommendations by way of the site's electronic storefront. These pre-lookup items may be based on highest product acceleration and most popular selections over all customer persona. Server 803 subsequently receives an identification of the customer, either through a cookie or by customer log-in to the site at step 804. Also, the server 803 receives a customer product inquiry at step 806 for example through a click or a typed entry into the customer's client interface. Server 803 looks up the customer's ID on database 805 and determines an optimal recommendation or response to the customer's inquiry at step 810 using the affinity engine and any inputs relevant to this response received from the customer. The server 803 then provides the best determined recommendation and response to the customer based on post-lookup knowledge of the customer at step 812.

In large catalogs or inventories of products, it is possible for products to have only a moderate affinity to one another, but have a stronger affinity to a class, type, category, or segment of related products. Therefore, an affinity can be determined not only between a pair of products (product-to-product affinity), but also between a product and a category or segment of products (product-to-segment affinity) as well as between segments themselves (segment-to-segment affinity). The affinity engine is designed in some embodiments to search for acceptable affinities in an ordering which is in an exemplary embodiment: first, product-to-product affinities; second, product-to-segment affinities; and third, segment-to-segment affinities. This can be done for example by deciding at each phase of the analysis whether a sufficiently great affinity has been found for the product/segment under consideration, and if not, then the system moves on to the next phase of analysis.

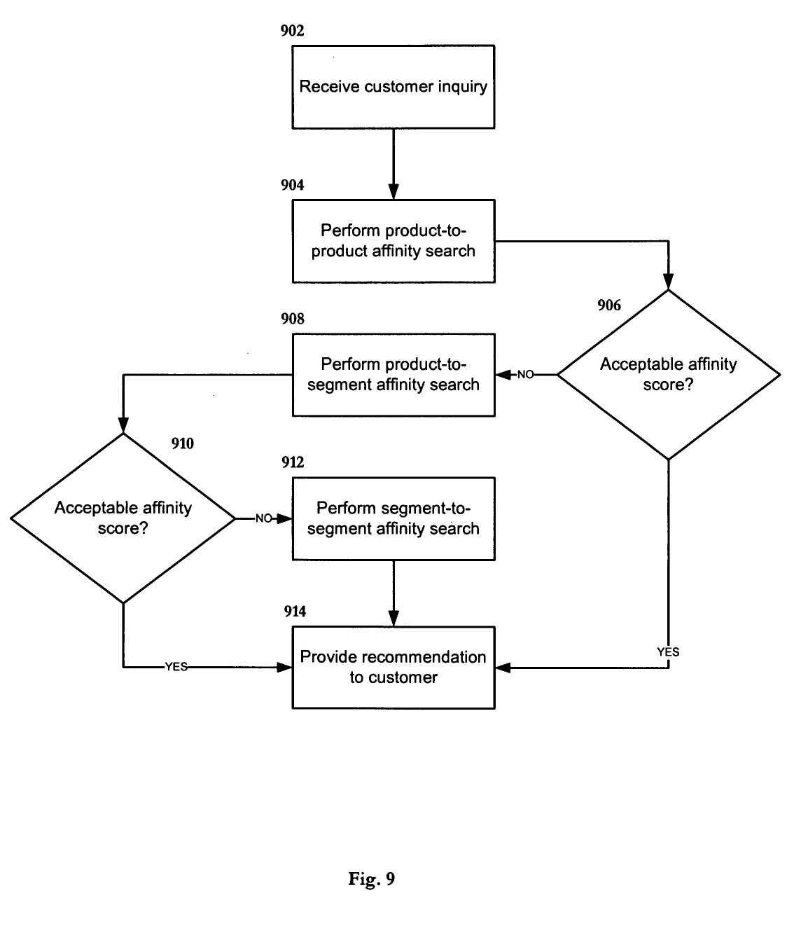

FIG. 9 illustrates the sequence of steps in performing affinity-based decisions at the product and segment levels. A customer inquiry is received by the affinity engine at step 902. The affinity engine attempts to determine a product-to-product affinity score at step 904 based on the customer's inquiry. If a satisfactory or acceptable affinity is found, the results are provided to the customer at step 914 in the form of a recommendation. Otherwise, the system performs a product-to-segment affinity score at step 908. If this score is acceptable, then the resulting recommendation is returned to the customer as above. Otherwise, a segment-to-segment affinity score is calculated at step 912, whose resulting recommendation is returned to the customer.

In product-to-product affinity analysis, the system can be configured to prioritize affinities when several equal or similar affinity scores are determined for several corresponding products. In some embodiments, preference is given to products that the customer has indicated a recent interest in or has purchased recently. In other embodiments, the average or mean purchase price is considered the primary factor in the decision. A ranking or ordering of product recommendations for products that return equal or similar affinity scores can thus be performed based on the settings determined by the vendor. Alternatively, the decision factors above can themselves be included in the calculation of the affinity score to differentiate one product from another.

We now look at a basic example of how product-to-product affinity and product-to-segment affinity are used in the context of online retail. Consider a clothing vendor with a Web site hosted on a server, e.g., the Apache server, coupled to or including an affinity engine as disclosed herein, and furthermore coupled to a data source for the purpose of conducting online sales of items of clothing from the seller's inventory. A customer using a client program such as a Web browser, e.g., Mozilla Firefox, visits the seller's site by following a uniform resource locator (URL) link to the site. The customer either logs in or otherwise becomes identified to the server through a cookie on the customer's computer, or the customer is anonymous and the server and/or affinity engine determine a course of response based on the customer's actions while visiting the site. The customer indicates that she is interested in a clothing accessory, e.g., belts. The affinity engine then performs a product affinity determination to determine a best one or plurality of belts to present to the customer. This grouping of items to be presented may be a result of looking up the customer's gender for example. If the customer is a woman and this information is stored and available to the server, or if the customer otherwise indicates from her activity at the site that she is a woman, then the subgroup of women's belts are presented to the customer.

What happens next is determined by the design of the affinity engine, server, and potentially a configurator tool used by the operator of the site to determine the specific operations of the site. In some embodiments, the system next determines other products to present to the customer using product-to-product affinity calculations. However, in some cases, there may not be a further strong or sufficient affinity between the product in question and other individual products in its category. Here, the system can move on to determine product-to-segment affinity with the available product segments and recommends for example the top product or products from within the segment with a strong affinity to the original product of interest. The top products may be determined to be the most popular overall, the most popular among persons having something in common with the customer, the products matching the customer's price purchase profile, or another criterion. In each case, the “goodness” of the calculated affinities can be set my the merchandiser and become inputs or constants used by the affinity engine in generating the outputs of the affinity engine.

It should be noted that product sales can be described by an “acceleration” metric that indicates the rate at which the product has improved its sales among a segment of products or customers as a result of affinity analysis of the product and its placement. The acceleration for the sale of a product can be quantified and used by the present affinity engine systems and methods to improve overall shopping satisfaction and efficiency. Therefore, a product with high or highest acceleration can be chosen for cross-selling or placement by an online retailer to maximize the sales results from this product and potentially from associated products as well. For retail storefronts welcoming new or unknown visitors, the highest accelerated products among some or all product segments are included in the set of products presented to the new or unidentified visitors as these are likely candidate products to generate retail interest in the visitors.

Note that more than one type of affinity can be used to judge the overall affinity of a product or customer to another item. For example, an affinity engine may calculate (in some pre-determined order) a first affinity (e.g., price affinity) followed by a second affinity (e.g., brand affinity), and so on. A combined, or weighted combination, affinity calculation would then be used as a final and overall affinity measurement. A “good” brand affinity may be determined to be outweighed by an “excellent” price affinity in some cases, and a brand unlike the customer's regular brand may be recommended first to the customer. It is desirable to recommend or cross-sell products that have simultaneously high affinities for more than one reason, and products which have low affinities in multiple categories are poor choices for recommendation and cross-sell.

In segment affinity calculations, the segments or product categories from which customers purchase goods are tracked and stored for analysis. This can be extended to browsing and other inquiries and is not limited to actual purchases of the products.

The examples provided above are intended to provide details of the operations of certain features of the present affinity engine. It should be understood that other features can also be included or substituted for those given herein in detail, and as would be appreciated by those skilled in the art upon reviewing the present description. Accordingly, it should be appreciated that a merchant, Internet service provider, e-commerce server vendor, or others may customize the features and settings of their affinity server to their specific needs. It is sometimes useful to have human developers and architects (both business and technically oriented) working in conjunction with the automated systems described herein for optimum results. The present systems allow for optimization and adjustments by allowing input from human operators from time to time to calibrate the performance of the systems. A “configurator” tool is optionally provided herewith to allow human operators to configure the operation of the affinity engine and associated components. The configurator can expose little, some, most, or substantially all of the workings of the affinity engine to the operator to allow adjustment of the settings of the same. The configurator may be a clause-based rules configurator that uses machine-readable code clauses to configure a rule used by the affinity engine. One end result is that the recommendations made to customers can be influenced by the settings of the affinity engine as configured by the configurator. The configurator may be in practice provided as a separate tool implemented in hardware and/or software, and may alternatively be provided as a component of the affinity engine or the server coupled thereto. The configurator may further determine the order of the rules that are executed by the affinity engine. In some instances, a merchandiser may use the configurator to set a “goodness” criterion for product-to-product or category-to-category affinities, for example.

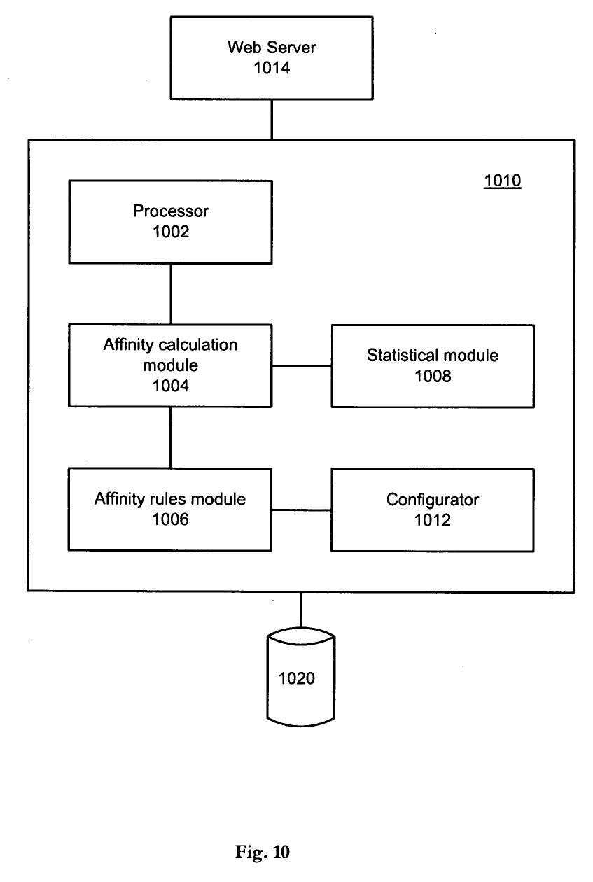

FIG. 10 illustrates an exemplary block diagram of an affinity-based e-commerce engine 1010. The affinity engine 1010 is coupled to a Web server 1014 for interacting with customer clients and a network. The affinity engine 1010 is also coupled to a database 1020 or equivalent database management server. The affinity engine 1010 comprises a processor 1002 which processes information and makes determinations and recommendations as outputs thereof. An affinity calculation module 1004 is comprised of hardware and/or software executed in hardware, for example being incorporated into processor 1002. The affinity calculation module determines affinity scores for various products and other entities as discussed herein. The affinity calculation module is coupled to a statistical module 1008 that performs statistical data analysis on data available to the affinity engine 1010. The affinity calculation module is also coupled to an affinity rules module 1006 that implements and executes rules as determined by the designers of the system and as will guide the system's outputs and recommendations. The rules module is optionally coupled to a configurator 1012 that can configure the rules and other aspects of the operation of the affinity engine 1010. It should be appreciated that the present example is only for illustrative purposes, and other equivalent and alternative configurations are possible. For example one or several of the above components and modules can be implemented within the other modules, especially if the implementation is circuit and/or software code based. Additionally, one or more modules can be broken up into separate modules for the purpose of programming or design efficiency or other reasons.

An affinity-based e-commerce system according to the present invention includes a processor capable for processing input data and instructions relating to determination of affinities, and provides an output corresponding to the affinities, for example in the form of a numerical or coded output that describes a quantitative or qualitative measure of the affinity. Furthermore, the system can operate on the data available to the system substantially in real time (as customers interact with the e-commerce retail site) in some embodiments. However, in other embodiments, affinity calculations and data processing by the affinity engine can take place in other than real time, for example, offline or in the background. Look-up tables and other data structures can be generated by the system so that the system does not need to do excessive computations during use and operation. Optimization and pre-processing of data and input parameters can be performed asynchronously if so configured. Other offline data processing calculations and simulations, sorting, organizing, caching, moving, converting, encrypting, backing up, and compressing of the data are among the operations that the processor (or processors) can perform on the data as part of a real time or non-real time system as given herein.

Data analysis to generate useful affinity selling results and reports can be scheduled to occur at times of low system activity, or periodically (e.g., nightly), or as directed by a human operator of the system. Certain types of affinity data are time-sensitive and can become “stale” if not processed and used in a timely way. For example, in the entertainment or sports or investment industries, certain data may need to be kept as current as a day or less. While in other contexts, for example, in the context of brand affinity and price affinity, this data may remain useful for months or years. Merchants can be enabled under embodiments of the present system and method to control the time period over which data is stored and analyzed to suit their needs and context. The system can perform data cleanup of intermediate calculation results or other data that becomes stale, unused, found to be inaccurate, or otherwise unnecessary for future operation. Data cleanup can be conducted periodically, e.g., on a weekly basis, or when the system load is low, or as directed by the system's operators.

The affinity engine can be designed in some embodiments to consider the time lapse between events in determining the relative significance of the events. For example, if a time period of one year is chosen as a meaningful time period during which events that occur bear some relevance to one another or to an expected present event, then the system can be designed to ignore data from events that took place more than one year ago. Alternatively, the system can be designed to lower the significance (reduced by a weighting factor for example) of an older event. That is, the system can be designed to consider more recent events as being more relevant than older events in calculating an affinity score.

Another benefit of using the present affinity-based systems and methods is the enhanced reporting ability provided by the affinity engine. This reporting can be incorporated into a reporting module that is built into the affinity engine itself, or built into another portion of the system for the purpose of guiding future retail activities, accounting, and evaluating the performance of the system and methods. In some instances, the reporting includes a report describing which products are actually being recommended by the affinity engine. The reporting may also describe the location within the e-commerce site the product are being recommended. In addition, the report may describe the number of times the recommendations made were “clicked on” (followed) by the site visitors, and the context in which they were clicked on. This may help evaluate how effective and timely the recommendations were. Furthermore, the reporting may also include a report on which products and how many times they actually resulted in a sale. This information is again indicative of the value of the affinity engine and its recommendations and instructive of how to modify the affinity engine's behavior to achieve increased sales.

The reporting can indicate whether the context in which a recommendation was made is effective. For example, by tracking how many recommendations resulted in a click or a sale, the site operator can determine that a high-end fashion bag was recommended in the “correct” context (e.g., to female customers with larger budgets) as opposed to a recommendation made in the “wrong” context (e.g., male students with low budgets). More specifically, if an expensive ladies' hand bag appears to have a high affinity with fashion scarves, but this cross-sell recommendation is not presently configured to be offered to female shoppers with larger budgets, the affinity engine can be reconfigured to make this paired recommendation to this segment of customers.

Other enhancements to the operation of the system can be developed by proper analysis of the affinity engine reports to determine when and why certain combinations of products resulted in noticeably effective or poor conversions and sales. The overall contribution of the affinity engine's recommendations to revenue (money generated from product sales) is useful to the operation of an online retail site. Understanding the contributions or added contributions to revenue from a site, along with a breakdown of such revenue gain by recommendation type, recommendation context, relative conversion performance by product and/or category, and other such information is a benefit of the present affinity engine system and methods. In this way, a merchandiser can examine a report for information and data relating to the best performing recommendations based on contributions to site revenue and the context in which those best performing (and conversely worst performing) recommendations were made.

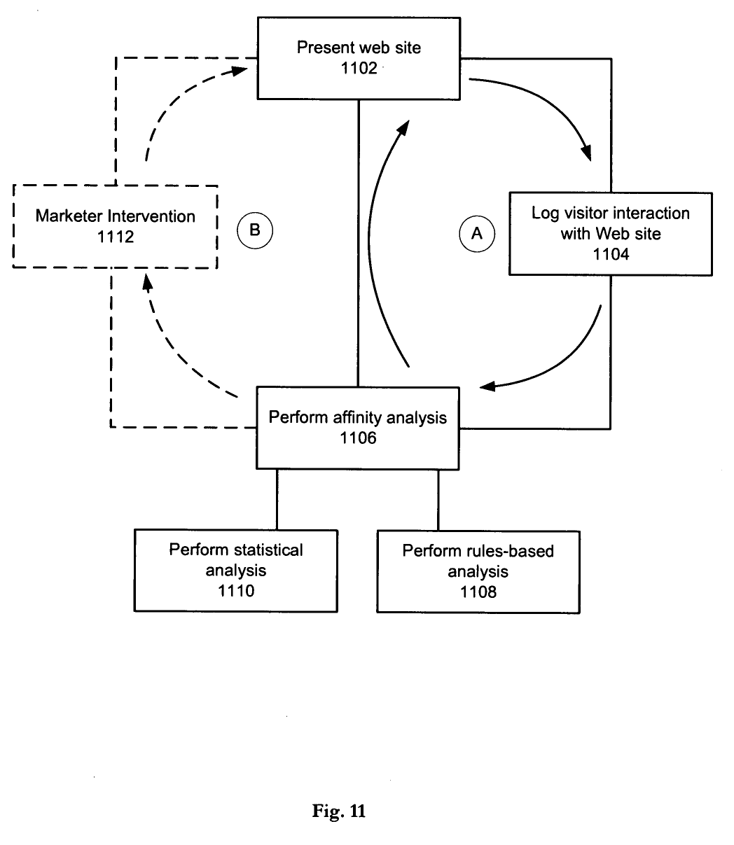

FIG. 11 illustrates an exemplary logic flow diagram describing the analysis steps according to an exemplary embodiment of the invention. The hosting entity presents a retail Web site to a customer over a client-server connection at step 1102. The affinity-based e-commerce system logs the visitor's interaction with the Web site at step 1104. Affinity analysis is performed using the required inputs and data as previously discussed at step 1106. An affinity engine may perform rules-based analysis at step 1108 and/or statistical analysis at step 1110, although some or all of this analysis can be incorporated into an affinity analysis step 1106. Once an appropriate affinity-based decision or output is generated by the affinity engine, the result is sent to the Web site as a recommendation or cross-sell suggestion. This completes a closed automated logical loop (A) without the need for intervention by a marketer in the process. To illustrate this point, loop (B) is shown to the left of the figure with a step of marketer intervention 1112 shown. The present invention allows for the closed-loop analysis process (A) without the need for marketer intervention. However, in some instances, an operator or marketer can take over the process to better optimize it or to correct inefficiencies or errors.

We now turn to a specific detailed discussion of some preferred embodiments of the present affinity-based e-commerce system and methods. It should be appreciated that other alternative or equivalent ways of implementing this using the present system and methods are available, and will be understood by those skilled in the art.

When an order is placed in a commerce site, a SubmitOrder message is sent from the purchase process pipeline. Normally, this message is received by the fulfillment system to get the goods to the customer. In addition to the fulfillment recipient, another recipient (SubmitOrderEventListener) also receives the SubmitOrder message, and the submit order message is added as a tab-delimited line in a file (OrderFileLogger, order_{timestamp}_{uniqueid}.data) by a data collection component for queuing and message handling (OrderLogEntryQueueSink, OrderLogEntryGenerator).

The previously-mentioned data warehouse is provided with a data load system, including load monitoring and balancing system in some embodiments, due to the potentially high number of events per unit time that can take place in a busy e-commerce system. The present system can record each site visit, each product catalog update, and each order, or a selected subset of the same. In addition, it may also record each individual product browse event.

The present system further includes a distributed load architecture that allows many loader instances to be used to load data into the data warehouse according to some embodiments. This allows each customer to tailor the number of servers he or she needs to load the data for his or her site. For example, a customer with 48 e-commerce servers may need 6 loader servers to load the data into the data warehouse. A different customer may need 8 loader servers to accomplish the same task, while a different customer may only require one loader servers. The present data warehouse load architecture can accommodate all of these customers.

When a certain number of submit order messages have been logged, e.g., 5000 messages, or when a certain time period has elapsed, e.g., 24 hours, the OrderFileLogger rotates the log fileby closing the existing log file, creating a new log file, and sending a LogRotationMessage. The LogRotationMessage contains the name of the file that was just closed.

Some embodiments of the present invention employ a virtual file system. A logging system includes a class, (e.g., RotationAwareFormattingFileLogger) class (of which, e.g., the OrderFileLogger is an exemplary instance), that uses a virtual file system, e.g., the ATG Virtual File System (VFS) API, to manage the log file. VFS includes a set of interfaces that allow an application to store and retrieve files, without needing to be aware of the physical storage mechanism. With a VFS, an application can access a VirtualFile object by name. The virtual file (e.g., VirtualFile) interface has a name, and provides access to an input stream (e.g., InputStream) and an output stream (e.g., OutputStream) in this preferred exemplary embodiment.

The VFS includes several interfaces, including LocalFileSystem, which is an implementation of the VirtualFileSystem interface that uses the underlying operating system (“OS”)-level file system as the source of its VirtualFile objects. When a LocalFileSystem is created, a directory in the OS-level file system is identified and used as the toot of the LocalFileSystem, e.g., in a directory on a server at “C:\MyCompany\MyServer\home\logs\submitorder.” In that directory a file named “order_{—}1.data” can be created. If a LocalFileSystem is created, with “C:\MyCompany\MyServer\home\logs” as its root, that file can be accessed by asking the LocalFileSystem object for the file at “submitorder/order_{—}1.data.” The filename used in the LogRotationMessage is the path within the virtual file system at “submitorder/order\_{—}1.data” in this example.

There are a number of other implementations of the VFS, several of which can be used with the present system's logging features. In some illustrative examples, these include implementations can access remote servers (e.g., RemoteFileSystem), handle a compressed (e.g., zipped) file as a file system (e.g.; ZipFileSystem), present a content repository as a file system, a switchable file system, that switches between multiple underlying virtual file systems, and a create a file system in memory, which is useful for testing purposes.

Various embodiments of the present system use a local file system (e.g., LocalFileSystem) whose root is at the “logs” directory under $MyServer_HOME, or $MyServer_HOME/servers/$SERVER using named servers. The logging and rotating of log files is done for a number of types of log data. In addition to submit order events, log files are maintained for site visit events, as well as for product catalog change events.

The present features of the preferred embodiments can be run on a computer system as modules installed in, or, or with an e-commerce server system including an affinity selling module or system. The following outlines some preferred embodiments of data loaders, and are not intended by way of limitation, as other embodiments will be appreciated by those skilled in the art. In conjunction with the operation of the other modules and features of the present system, a data loading module or system is employed for optimum handling of data transfer and loading into and out of the data warehouse. In some embodiments, the data loader module is implemented in a physically separate server machine or dedicated machine. In this case, the data loader or loader server may not handle customer requests, which are handled at another module or server. The loader in the embodiments using a loader server are carried out as back-end processing instances, which collect and load data from the log files into the data warehouse.

A loader manages the data warehouse loader “repository.” The repository tracks the progress of log file loading. When the loader receives a log rotation message (e.g., LogRotationMessage) and creates a new entry in a load queue item descriptor in the repository. Operation of the loader can be scheduled, e.g., nightly, and the loader instances are activated at their pre-assigned times, e.g., at 2 a.m., and claim an entry from the queue. The loader creates an entry in a load progress item descriptor, setting the load progress status for that log file to “In Progress” for example, and sets the number of records processed to zero. The loader then uses a client lock manager (e.g., ClientLockManager) to acquire a lock on the load progress item.

The loader can also create a new transaction when needed. The loader reads a line from the log file, processes it, as discussed in more detail below, reads another line, processes that line, and so on, until it has processed a certain number (a “batch size”) of lines. Assuming no errors occurred, the load progress is updated to indicate the number of records processed. Then, the create transaction, process batch, commit transaction cycle is repeated until the entire log file has been read. At that point, the load progress item has its status updated to “complete”.

If an error occurs while loading a batch of data, the transaction is rolled back, the load progress status changes to “failed”, and a status detail is added to the load progress item. Loads that have failed can be viewed from the administration servlet for the loader component.

Another exemplary feature of a loader module is its ability to handle a non-recoverable failure such as a JVM crash while a log file is being loaded. The load progress indicator for that file will still be indicating “in progress.” To handle this situation, when a loader starts up, before it receives input from in the loader queue, the loader first determines the load progress items that are “in progress.” The loader then uses the ClientLockManager to obtain a lock on the load progress item. If the lock is not granted, this indicates that another process has the lock on the item and is actively loading the file. However, if the lock is granted to the loader, then a loader was loading the file, and the loader crashed. In that case, the Loader will continue loading the file, starting from the first record that has not yet been processed.

The Loader may also use the VFS to access log files. When loading a file, the loader obtains a file from the VFS at a path found in the LogRotationMessage. Using the example above, this is “submitorder/order_{—}1.data.” So, the Loader VFS is configured such that requesting the file from the VFS returns the same file that the logger used. This can be done in several ways, for example, through an operating system-level file sharing mechanism. File sharing systems that can be used include NFS or SMB/CIFS/Windows.

The e-commerce server can export or share the “C:\MyCompany\MyServer\home\logs” directory, and the Loader can mount that to “/net/dcs/logs” and have its VFS be a LocalFileSystem whose root is “/net/dcs/logs.” If both the e-commerce server and the Loader are running on the same machine, the Logger and Loader VFS can point to the same directory.

When the Loader (OrderSubmitLoader) reads a line from the log file, it is parsed, and sent to a loader data pipeline (OrderSubmitPipelineDriver). The system may include a pipeline manager module, and the pipeline may be a PipelineManager component, with a number of pipeline processors that perform some action on the line. These processors include looking up dimensional data in the warehouse, calculating affinity between products, and outputting facts about each item in an order to the data warehouse.

Many applications use a repository group list manager module (e.g., “RepostioryGroupListManager”) that maintains lists of segments that an application, administrator, or merchant deems “interesting.” In addition, the lists of segments can be ordered or ranked or scored by importance or relevance in some context. When an event happens on a site, some loggers include the list of segments the user was a part of when the event occurred. However, a site may also have hundreds of segments defined. As a result, when a log event occurs, a segmenting logic module can be queried as to whether a given item or person is a member of a segment or not.

The RepositoryGroupListManager maintains lists of segments of interest, for an application that uses segments in its log entries. When an event occurs, the RepositoryGroupListManager provides a list of interesting segments and the result is placed into the log file with the other data about the event. This limits the number of segments that need to be determined about membership.

An affinity data warehouse may be kept as discussed above and contain a plurality of data tables housing such information as: product purchases for each profile; category purchases for each profile; and price information (min, max, average, standard deviation) for each profile.

Certain product to product and category to category data are stored, both globally and for each customer segment of interest. When a product is purchased by a customer, the system determines the list of other products this customer has purchased over the last N (e.g., 365) days. For each product pairing, we increment the number of times these products have been purchased by the same customer. So, if Alice bought a RunningCo Track Suit and a Acme Wristwatch, the product affinity data tables would indicate that the RunningCo Track Suit/Acme Wristwatch pair has been purchased by the same customer once. If Betty buys the same two items, the RunningCo Track Suit/Acme Wristwatch pair count would be incremented, indicating that the pair has been purchased by two customers. If Alice later buys the Super Light Sneakers, when the order submit pipeline is run, the system determines the other products Alice bought in the past year, and finds the watch and track suit. So, the RunningCo Track Suit/Super Light Sneakers and Acme Wristwatch/Super Light Sneakers product pair data is incremented.

The affinity engine system also captures data that also applies a weighting algorithm to the above counts, which is determined by how many days apart the two products were purchased. This is known as “spread.” If a products were purchased on the same day, then the products probably have a closer relationship to one another than if the products were purchased many days apart. In some embodiments, the result of this weighting yields a real number between 0 and 1, with 0 indicating the least possible affinity, and 1 representing the most possible (or perfect) affinity. The affinity score of a product pair is stored along with the number of times any user has purchased a product pair, as well as the total spread across all purchases of the pair.

The calculation used to determine the affinity is done by an affinity calculator (e.g., “AffinityCalculator”) component. For example, a fractional exponent affinity calculator (“FractionalExponentAffinityCalculator”) uses an inverse root formula to model sharp initial affinity drop-off, followed by a more gradual slope down to zero.

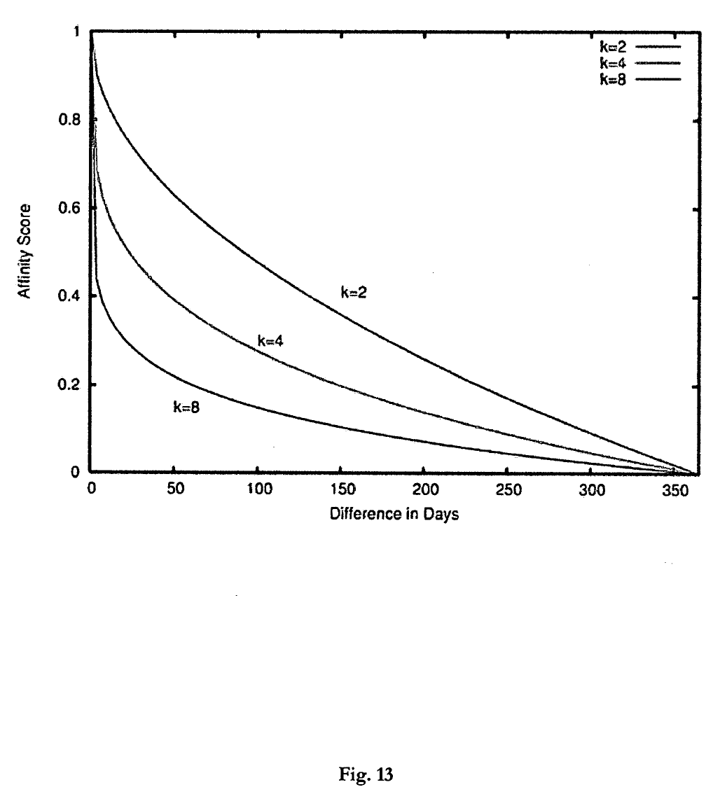

FIG. 13 illustrates a specific exemplary set of affinity scores calculated using the function f(x)=1−(x/N)̂(1/k), where x is the number of days between product purchases, N is the cutoff after which affinity is not considered as relevant (e.g., after 365 days), and k is a scaling factor that indicates the steepness of the initial slope of the curve. When k=1, this function is linear.

The AffinityCalculator can use a different implementation, if there is another affinity calculation required. For example, if products bought exactly seven days apart are determined to have a higher affinity than products bought five days apart, this can be formulated into the operation of the affinity calculator.

The present affinity engine can also take into account the notion of data aging and its effect on the relevance of paired events. Affinity pairs that occur most recently may be ranked higher than pairs that occurred in the past. If a customer purchased product A 50 days ago and product B 45 days ago, and if a different user purchased A 15 days ago and product C 10 days ago, the spread on each of these pairs is five days. However, when determining recommendations for product A, the affinity engine may give the result as “product C” rather than “product B” because the A-C pair was purchased more recently, and is therefore determined to be a more relevant, or stronger pairing than the pairing of products A-B.

In some embodiments, the aging of affinity data uses technique called “inflation.” Inflation introduces a new factor, that is multiplied into the affinity score. This factor increases in value every day by some fixed amount, generally by 1 divided by a window size of the affinity extraction process, for example 1/365 or 1/90. Inflation thus causes more recent pairings to have a higher affinity score, and to be ranked higher than other affinity scores that are older. For example, an inflation factor can be based on how many days between the day of interest and Jan. 1, 1970. So on Apr. 11, 2007, the number of days since Jan. 1, 1970 is 13614. Therefore, if the factor changes by 1/365 each day, on Apr. 11, 2007, the factor is 37.230. The next day, April 12, the factor will increase by 1/365 to 37.301.

Using our example above, if the affinity calculator determines that the affinity score for pairs that have a spread of five days is 0.685. If today is Apr. 11, 2007, the inflation factor 45 days ago was (13614−45)/365 or 37.175, and the inflated affinity score is then 37.175*0.685=25.465. The inflation factor 10 days ago was (13614−10)/365 or 37.271, so the inflated affinity score is 37.271*0.685 or 25.531. When making a recommendation for product A, the affinity engine will recommend product “C” over “B,” because the A-C pair has an inflated affinity value of 25.531, which is higher than the inflated affinity pair value for A-B, which is 25.465.

For performance and security reasons, the data warehouse is preferably accessible via back-end systems. To make some of the data in the warehouse available to the e-commerce servers, the Loader runs a scheduled extraction service (e.g., “ExtractorService”). The extraction service runs a series of Extractor module instances. One such instance is an affinity extractor.

An affinity extractor pulls up event data or facts from the data warehouse fact tables, and puts this data into the data warehouse extraction repository, which is accessible from the e-commerce server. Affinity data is only valid for a limited amount of time. For example, a site may only be interested in product affinity for purchases made in the last 60 days. So, the affinity extractor may make data that is older than a given threshold date irrelevant, stale, or reduce its value by aging it or otherwise lowering its weighted value.

A data warehouse extraction repository holds a summarized version of the affinity parts of the data warehouse. Where the data warehouse breaks the data down by day, the extract repository aggregates N days worth of data into a single record. Periodically, e.g., each day, the latest day's worth of data is added to the summary, and the data from the previous (N+1) days ago is subtracted from the summary. Now the Loader instance has run an extractor service, and the latest affinity data now appears in the data warehouse extraction repository. The customer-facing side of the e-commerce engine provides an affinity service component any required data from this repository.

The affinity extractor provides an abstraction of the extracted affinity data for the affinity “droplets.” Exemplary affinity droplets include: a product affinity droplet; a profile-category affinity droplet; a product-product (“ProductProductAffinityDroplet”) affinity droplet; and a category-category affinity (“CategoryCategoryAffinityDroplets”) droplet.

The above exemplary droplets have a “howMany” input parameter, which indicates how many products or categories should be returned in a recommendation. The ProductProduct and CategoryCategoryAffinityDroplets also have a “segment” input parameter, which takes the name of a segment to use to get products or categories based on a user segment. If no segment is specified, the highest priority segment the user is a member of is used. They also take a “global” input parameter, which, when true, gets products or categories. The ProductProductAffinityDroplet takes a “productId” input parameter, such that the output items should be the products that have the closest affinity to that product. Similarly, the CategoryCategoryAffinityDroplet takes a “categoryId” input parameter, the output items should be the categories that have the closest affinity to that category. These droplets service an “Output” output parameter. Within that Output parameter, the “items” parameter is set to the list of products or categories returned by the affinity service. If an error occurs while looking up the items, an “Error” output parameter is serviced.

As an example, the following JSP portions can be used to obtain a list of products that have the highest affinity for users in the same segment for the currently displayed product, whose ID is in the “productId” page parameter:

```
<dsp:droplet name=“ProductProductAffinityDroplet”>
  <dsp:param name=“productId” paramvalue=“productId”/>
  <dsp:param name=“howMany” value=“3”/>
  <dsp:oparam name=“output”>
```

Other customers who purchased this have also purchased in this example:

```
<dsp:getvalueof var=“items” param=“items”/>
<c:forEach var=“item” items=“${items}”>
  <dsp:tomap var=“product” value=“${item}”/>
  <dsp:a href=“product.jsp”>
    <dsp:param name=“productId” value=“${product.id}”/>
    <dsp:img src=“${product.smallImage.url}”/>
    <c:out value=“${product.displayName}”/>
  </dsp:a>
</c:forEach>
  </dsp:oparam>
</dsp:droplet>
```

Alternatively, combinations are possible. For example, if a customer visits the home page of the site, the site can find the three most commonly purchased product for a customer, and for each of those products, find the two products that have the highest affinity to each of them, thus recommending up to six products:

```
<dsp:droplet name=“ProfileProductAffinityDroplet”>
  <dsp:param name=“howMany” value=“3”/>
  <dsp:oparam name=“output”>
    <dsp:getvalueof var=“profileItems” param=“items”/>
    <c:forEach var=“profileItem” value=“${profileItems}”>
      <dsp:tomap var=“profileProduct” value=“${profileItem}”/>
      <dsp:droplet name=“ProductProductAffinityDroplet”>
        <dsp:param name=“howMany” value=“2”/>
        <dsp:param name=“productId” value=“${profileProduct.id}”/>
        <dsp:oparam name=“output”>
          <dsp:getvalueof var=“productItems” param=“items”/>
          <c:forEach var=“productItem” value=“${productItems}”>
            <dsp:tomap var=“productProduct”
            value=“${productItem}”/>
            <p>
            <dsp:a href=“product.jsp”>
              <dsp:param name=“productId”
              value=“${productProduct.id}”/>
              <dsp:img src=“${productProduct.smallImage.url}”/>
              <c:out value=“${productProduct.displayName}”/>
            </dsp:a>
            <c:out value=“${productProduct.description}”/>
            </p>
          </c:forEach>
        </dsp:oparam>
      </dsp:droplet>
    </c:forEach>
  </dsp:oparam>
</dsp:droplet>
```

“Affinity selling” using the present affinity engine and associated modules allows a page developer write pages that make product and category recommendations to customers. Useful information includes information relating to the relative ordering of products and categories. In some embodiments, absolute values of product pair affinity calculation scores are less relevant to the selling process than their values relative to one another. While one can study the raw affinity values in the data warehouse extract repository, a page developer may also forgo the need for this raw data, and if so, the system does not expose it through the AffinityService module and droplets.

The following further describes some preferred architectures for the present system and details preferred methods of its use. The affinity engine imports data from event logs populated by the e-commerce system's data collection API, as well from an order repository. This data is loaded by the data warehouse loader pipeline as discussed above. Data in the warehouse is extracted into the data warehouse extraction repository, which is accessed by an affinity engine runtime module.

Many affinity engine features use and analyze data at the segment level. Events used in affinity e-commerce analysis typically include a set of segments a customer was a part of when an event occurred, since customers can join and leave segments from request to request.

Affinity data in e-commerce employs two main types of events: “item purchase” and “item browse.” Referring to “item purchase,” the system employs a pipeline core to load item purchase data into the commerce data warehouse. The system includes an additional pipeline processor (AffinityPurchaseProcessor) to process an item purchase event.

Referring to “item browse,” product display pages are be instrumented with an ItemBrowseDroplet. This droplet will be put into pages by the page developer, who is responsible for implementing the business policy about what is considered a “browse” for that business. Each time a product is browsed, an ItemBrowseEvent is generated. The ItemBrowseDroplet uses an affinity segment priority manager to determine which segments will be included in the event. The following are exemplary properties of a “ItemBrowseEvent” event: profile, product, order, timestamp, and segments.

The “item browse” event is captured with the e-commerce server's data collection API, and is appended to a file using an instance of DatasetFileLogger, or into a database table using the DatasetSQLLogger. The “segments” property is a list, which can first be flattened to a single field before storage. A new instance of DataListner, PropertyFlattenerDataListener, will be created. This data listener will have a flattenProperties property, which is a list of event properties that will be flattened. A delimiter property indicates a delimiter character for each element in the property to be flattened. If this character appears in the element, it is duplicated in the output field. The dataListener property is a reference to “downstream” Nucleus component that performs the logging. The object sent to downstream DataListeners is a Map that contains the properties of the accessible input objects. The properties in the flattenProperties list are replaced by their flattened reprensentations. For example, if the input event ItemBrowseEvent may have the following exemplary properties and corresponding values,

| Property | Value |
|---|---|
| profile | profile: 2001 |
| product | product: prod5653 |
| order | order: o23342 |
| timestamp | 8-Aug-2006 11:21:32 |
| segments | {“Men”, “Fashonista”, “BigSpender”, “Cool, Hip”} |

the mapping (Keys-Values) is:

| Key | Value |
|---|---|
| profile | profile: 2001 |
| product | product: prod5653 |
| order | order: o23342 |
| timestamp | 8-Aug-2006 11:21:32 |
| segments | “Men, Fashonista, BigSpender, Cool, Hip” |

If the DatasetFileLogger option is used, each instance of the e-commerce server appends to its own log file so processes do not overwrite and corrupt log data for simultaneous events. The DatasetFileLogger is also set to rotate log files, as the data load process reads from the rotated files. Item purchase data is also loaded in a similar fashion.

The affinity engine uses the data warehouse to store information about customer and customer segment product browses and purchase behavior. Additionally, the affinity engine adds a number of data tables to the data warehouse. These tables are used to store affinity data for individuals and segments on a daily basis. These tables are summarized, and are used to load and expire operational affinity data, which can be queried from the affinity runtime module. The affinity engine further uses a “sliding window” technique in some embodiments, where old data is removed from the summaries, and fresh data is added, so only a finite amount (e.g., a year's worth) of data is considered in the affinity analysis. This retention and updating is configurable.

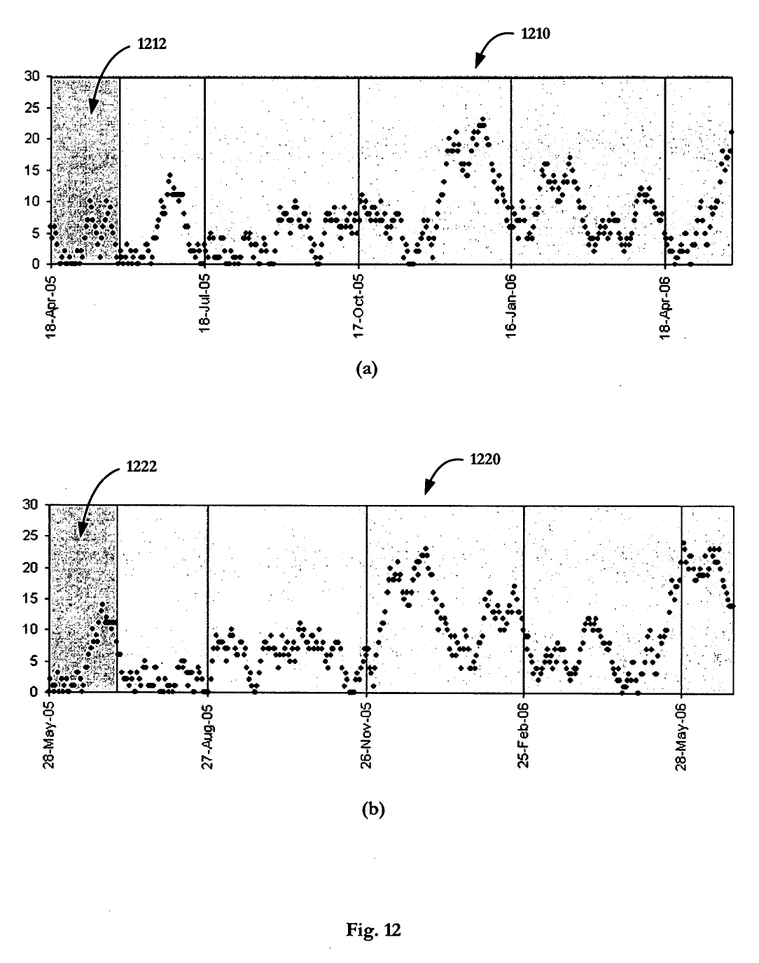

FIG. 12 illustrates the notion of retention of a finite window of data in the affinity analysis. Referring to FIG. 12(a), on May 28, 2006, the system only considers the daily data 1210 as far back as May 28, 2005. Data older than May 28, 2005 (1212) is not considered, but may still be retained for archival or detailed analysis. Referring to FIG. 12(b), about a month later, and on Jun. 26, 2006, the system only considers daily data (1220) as far back as Jun. 26, 2005. Note how the spike near the beginning of June 2005 falls out of consideration in the later window (1222), because it is more than a year old. Data not being considered is indicated by the darker shaded panel.

As mentioned previously, some or all embodiments hereof utilize four primary types of personal affinity data within the data warehouse: purchases by product, brand, category, and price data. In addition to the previous discussion of these affinities, the following detailed examples will help understand certain preferred but exemplary embodiments in the present context. Aggregate affinity is included in the data warehouse. These data tables maintain the relationships between products or categories by segment. There are four exemplary types of aggregate affinity data in the warehouse in a preferred embodiment: product purchased to product purchased, product browsed to product browsed, product browsed to product purchased, and category purchased to category purchased.

The affinity engine appends a series of pipeline processors into the core commerce order item loader pipeline chain, after which the processor chain is invoked for each event in the present illustrative embodiment. Each processor of the present illustrative embodiment includes a configuration flag that can be used to disable the loading activity for that processor. This can be used to limit the amount of time and data used to perform affinity analysis.

Item purchase data are loaded into the data warehouse by the core commerce reporting import pipeline processes before the purchase affinity pipeline processors are run. The affinity pipeline processors are inserted into the core commerce data warehousing loader's line item processor chain, and are run once per item purchase. Each processor will have an “enabled” flag that can disable the processor. In the warehouse, tables, profile, product, category, and day IDs come from a data warehouse ARF_LINE_ITEM table. Segment IDs come from a data warehouse ARF_SEGMENT table. In other embodiments, brand IDs are found by looking up the “brand” property of the product in the catalog for use in “brand affinity” calculations as described earlier.

The affinity-based system disclosed herein includes one or more processors that can be used herein, which can incorporate software, hardware, or generic or custom combinations thereof. Various embodiments of the present system also include a profile product processor. This processor takes the line item, and gets its profile, product, and day IDs. The item with those keys in the profileProductPurchaseFact item descriptor is found, or created if it does not exist, and its occurrences property is incremented.

In other embodiments, the system includes a profile category processor. This processor takes a line item, and gets the profile, category, and day IDs. The item with those keys in the profileCategoryPurchaseFact item descriptor is found, or created if it does not exist, and its occurrences property is incremented.

Still other embodiments of the present system include a profile brand processor. This processor will take a line item, and get the profile, brand, and day IDs. The item with those keys in the profileBrandPurchaseFact item descriptor is found, or created if it does not exist, and its occurrences property is incremented.

Yet other embodiments hereof include a profile price processor. This processor takes the line item, and gets the profile and day IDs. The item with those keys in the profilePricePurchaseFact item descriptor is found, or created if it does not exist, and its occurrences (e.g., minimum, maximum, average, and standard deviation price) properties are updated as appropriate.

In other embodiments, the present system employs a product affinity processor. This processor takes a line item, and obtains a profile and product IDs corresponding thereto, as well as a set of segments the customer belonged to at the time of the purchase. For other products purchased by that customer (e.g., found in profileProductPurchaseFact) in the past year (being configurable), and for each segment the customer belongs to, the item from productAffinityFact is retrieved. The purchasePurchaseOccurrences property is incremented, and the purchasePurchaseAffinity property is incremented by the affinity score as influenced by the difference in time between the last time the item was purchased, and the present time of the event.

In addition, embodiments of the present system may employ a category affinity processor. This processor will take the line item, and get the profile and category IDs, as well as the set of segments the user belonged to at the time of the purchase. For categories with a product purchased by that user (found in profileCategoryPurchaseFact) in the past year (being configurable), and for the segments the user belongs to, the item from categoryAffinityFact is retrieved. The purchasePurchaseOccurrences property is incremented, and the purchasePurchaseAffinity property is incremented by the affinity score determined by the difference in time between the last time the item was purchased, and the present time of the event.

Item browse data is loaded from either the rotated log files from the DatasetFileLogger, or from log tables populated by the DatasetSQLLogger. In both cases, records are read one at a time, or sequentially, and sent through a pipeline chain, whose processors populate the appropriate data warehouse tables. Product IDs are found in the event data. The data warehouse will provide a mechanism that will give a day ID for a timestamp, and a segment ID for a segment.

Another embodiment employs a browser affinity processor. This processor takes a browse event, and obtains a profile and product ID, as well as a set of segments the customer belonged to at the time of the browse event. For every other product browsed by that user (found in profileProductBrowseFact) in the past year (being configurable), and for each segment the user is in, the record from productAffinityFact is retrieved. The browseBrowseOccurrences property is incremented, and the browseBrowseAffinity property is incremented by the affinity score determined by the difference in time between the last time the item was browsed and the present time of the event.

In addition, according to some embodiments, for every or substantially every other product purchased by that user (found in profileProductPurchaseFact) in the past year (being configurable), and for each segment the user belongs to, a corresponding record from productAffinityFact is retrieved. The purchaseBrowseOccurrences property is incremented, and the purchaseBrowseAffinity property is incremented by the affinity score determined by a difference in time between the last time the item was purchased, and the present time of the event.

An affinity calculator is used to determine how closely related products or categories are based on the length of time between browses or purchases and other factors to determine an affinity score. The module AffinityCalculator is a Nucleus component in some embodiments whose class has a single method of interest: public double affinity(Date pDate1, Date pDate2).

This method takes two dates as input, and returns a value or score between 0 and 1, inclusive. Of course, another system of ranking the score is available, but the present example is given for illustrative discussion of a preferred embodiment. In this example, the higher the value, the stronger the affinity. The implementation (e.g., in a “FractionalExponentAffinityCalculator” module) uses a fractional exponent function to model drop-off of affinity over time. In some embodiments, the affinity score is defined at least in part by a function f(x)=1−x̂(1/k) according to the definitions used earlier.

Within the present architecture, an affinity e-commerce data warehouse includes a schema operational as follows: The e-commerce server hereof is coupled to data tables, e.g. a table “DCS_PROD_AFF_FACT” which contains, for a given product pair, segment, and day, information about relationships between two products. A data structure “PURCHASE_PURCHASE_OCCURRENCES” holds a number of times product 1 was purchased by customers who also purchased product 2 in the last N (e.g., by default 365) days. PURCHASE_PURCHASE_AFFINITY holds the purchase to purchase affinity score where product 1 was purchased by users who also purchased product 2 in the last N days. PURCHASE_PURCHASE_INFLATED holds the inflated affinity score, which is the product of PURCHASE_PURCHASE_AFFINITY and INFLATION. PURCHASE_PURCHASE_TOTAL_SPREAD holds the total number of days between purchases of the pair. PURCHASE_BROWSE_OCCURRENCES holds the number of times product 1 was browsed by users who also purchased product 2 in the last N days. PURCHASE_BROWSE_AFFINITY holds the browse to purchase affinity score where product 1 was browsed by users who also purchased product 2 in the last N days. BROWSE_BROWSE_OCCURRENCES holds the number of times product 1 was browsed by users who also browsed product 2 in the last N days. BROWSE_BROWSE_AFFINITY holds the browse to browse affinity score where product 1 was browsed by users who also browsed product 2 in the last N days. To eliminate duplication, PRODUCT_{—}1_ID comes before PRODUCT_{—}2_ID lexically: For example, data about a pair of products “prod6789” and “prod1234” is put in the record where PRODUCT_{—}1_ID is “prod1234,” and PRODUCT_{—}2_ID is “prod6789.” INFLATION is the inflation value used for the day of this pairing event.

The DCS_CAT_AFF_FACT table contains, for each category pair, segment, and day, information about relationships between two category. PURCHASE_PURCHASE_OCCURRENCES holds the number of times a product in category 1 was purchased by users who also purchased a product category 2 in the last N (e.g., by default 365) days. PURCHASE_PURCHASE_AFFINITY holds the purchase to purchase affinity score where a product in category 1 was purchased by users who also purchased a product category 2 in the last N days.

The Affinity runtime database contains a summary of the data kept in the data warehouse. In particular, it aggregates daily data into single records, and typically mostly or only contains data from a limited period of time. It represents a “sliding window” of data, where information about today's activities are added to the summaries, while information about activities that happened over 365 days ago are subtracted from the summaries. Periodically (e.g., daily), the data warehouse will be queried for the records in the source tables that have the DAY_ID of the previous day, adding the OCCURRENCE and AFFINITY values into the corresponding summary table.

The DCSX_PROF_PROD_PURCH_FACT_SUM table contains the number of times a person purchased a given product in the past N days; The DCSX_PROF_PRICE_FACT_SUM table contains the minimum price paid, the maximum price paid, the average price paid, and the standard deviation of the prices in the past N days; The DCSX_PROD_AFF_FACT_SUM table contains, for each product pair, segment, and day, information about relationships between two products.

PURCHASE_PURCHASE_OCCURRENCES holds the number of times product 1 was purchased by users who also purchased product 2 in the last N (default 365) days; PURCHASE_PURCHASE_AFFINITY holds the purchase to purchase affinity score where product 1 was purchased by users who also purchased product 2 in the last N days; PURCHASE_PURCHASE_AVG_SPREAD holds the value of PURCHASE_PURCHASE_TOTAL_SPREAD from the fact table, divided by PURCHASE_PURCHASE_OCCURRENCES. BROWSE_PURCHASE_OCCURRENCES holds the number of times product 1 was browsed by users who also purchased product 2 in the last N days.

BROWSE_PURCHASE_AFFINITY holds the browse to purchase affinity score where product 1 was browsed by users who also purchased product 2 in the last N days; BROWSE_BROWSE_OCCURRENCES holds the number of times product 1 was browsed by users who also browsed product 2 in the last N days; BROWSE_BROWSE_AFFINITY holds the browse to browse affinity score where product 1 was browsed by users who also browsed product 2 in the last N days

The DCSX_CAT_AFF_FACT_SUM tables contains, for each category pair, segment, and day, information about relationships between two category. OCCURRENCES holds the number of times a product in category 1 was purchased by users who also purchased a product category 2 in the last N (default 365) days. AFFINITY holds the purchase to purchase affinity score where a product in category 1 was purchased by users who also purchased a product category 2 in the last N days

Periodically (e.g., daily), data from N (e.g., 365) days ago is subtracted from the runtime summaries. For each summary table, the fact table is queried for the daily information from N days ago. For each corresponding entry in the summary table, the OCCURRENCES and AFFINITY values are removed.

This is done by the affinity extractor component. This component keeps a record of which days' worth of data currently appears in the summary tables in the extraction repository. Each time the extractor is run, this list of days is compared with the list of days that should appear in the summary. If there are days in the “currently appears” set that are not in the “should appear” set, the extractor will expire (subtract) the data from those days from the summary. If there are days in the “should appears” set that are not in the “currently appears” set, the extractor will extract (add) the data from those days to the summary. These lists appear in the WarehouseRepository in the extractStatus item descriptor. Items in this descriptor have the properties itemType, whose value is the name of the warehouse affinity item descriptor that is summarized, and days, the set of days whose data currently appears in the extract repository. As the extractor adds and removes data from the extract repository, it updates the extractStatus to reflect the current state of the extract repository. The affinity extractor has a property extractionWindow that determines how many days' worth of data should appear in the extract repository. The default value is 90 days.

As an example of the productAffinityFact warehouse item, suppose that an extraction window is seven days, and the extraction service has never been run before. In this case, there is no extractStatus for productAffinityFact. The first time the extraction service is run, a new status item is created, with no days, because no data has been extracted into the extract repository. Since the extract window is seven days, the “should appear” set includes the seven days before the present event's day. So, on February 8, this set would include the days from February 1 to February 7. Since the “should appear” set includes seven days that do not appear in the “currently appear” set (which is empty), the extract service finds all of the data warehouse records in productAffinityFact that occurred on those days, and adds them to the extract repository. The status days is then updated to include the seven day items.

If the scheduler is configured to run the extraction service every two days for example, the next time it runs will be on February 10. On this day, the “should appear” set contains the seven days before this day, or February 3 to February 9. The “currently appears” set contains the same value that was set above, namely the days from February 1 to February 7. Since February 1 and 2 appear in the “currently appears” set and not in the “should appear” set, the extraction service looks up the data warehouse items for February 1 and February 2, and subtracts the values from the extract repository, and removes their day items from the extract status. Since February 8 and February 9 appear in the “should appears” set and not in the “currently appears” set, the extraction service looks up the data warehouse items for February 8 and February 9, and adds the values to the extract repository, and adds their day items to the extract status.

The “should appear” set counts back from the day before today (rather than just from today), because there is a strong chance that, due to scheduling, data in the warehouse is added on a later day than when the event occurred. As a result, it is possible to miss data during extraction. The affinity extractor includes a flag useful for diagnostics. If this flag is true, the “should appear” set uses today's day item as the latest in the set, instead of the day before today.

In some embodiments, an extraction service invokes a set of “measurement handlers,” which update the summary item in the extract repository. AffinityExtractor.MeasurementHandler is an interface that all measurement handlers must implement. In a preferred embodiment, this interface has a single method:

```
public interface MeasurementHandler {
  public void handleMeasurement(RepositoryItem pFact,
      MutableRepositoryItem pSummary,
      boolean pAdd) throws RepositoryException;
}
```

Some exemplary measurement handlers that can be used in embodiments of the present system and methods include:

IntegerMeasurementHandler
Takes a fact property name and a summary property name in the constructor, and adds (or subtracts) the fact value to (or from) the summary value. Both properties are of type Integer.

DoubleMeasurementHandler
Takes a fact property name and a summary property name in the constructor, and adds (or subtracts) the fact value to (or from) the summary value. Both properties ate of type Double.

TimestampMeasurementHandler
Takes a fact property name and a summary property name in the constructor, and if pAdd is true, sets the value of the summary property to that of the fact property if the fact property is more recent, otherwise, it does nothing. Both properties are of type Timestamp.

MinMaxDoubleMeasurementHandler
Takes a fact property name, a summary property name, and a flag indicating if the measurement handler should update the summary if the fact value is greater than the summary, or if the fact value is less than the summary.

AverageAndStandardDeviationMeasurementHandler
Takes the fact average property name, the summary average property name, the fact count property name, the summary count property name, the fact standard deviation property name, the summary standard deviation property name, the summary minimum property name, and the summary maximum property name. When invoked, this computes the average and standard deviation values for the summary item.

Additional measurement handlers can compute an average spread value of an item. For example:

AverageSpreadMeasurementHandler
Takes the summary affinity property name, the summary occurrences property name, and the summary total spread property name. Each time the measurement handler is invoked, it will divide the value of the spread property by the value of the occurrences property, and store the result in the average spread property.

These are used by the affinity extractor to determine what operations need to be invoked to update the summary for the corresponding fact item descriptor. For example, the productAffinityFact data warehouse item descriptor has the properties purchasePurchaseOccurrences and purchasePurchaseAffinity that need to be extracted and expired from the aggregateProductAffinity extract repository item descriptor using two exemplary metric handlers:

```
handlers = new MeasurementHandler[ ] {
  new IntegerMeasurementHandler(“purchasePurchaseOccurrences”,
        “purchasePurchaseOccurrences”),
  new DoubleMeasurementHandler(“purchasePurchaseAffinity”,
        “purchasePurchaseAffinity”)
};
```

Each time a productAffinityFact is processed, the IntegerMeasurementHandler adds (or subtracts) the value from productAffinityFact.purchasePurchaseOccurrences to (or from) aggregateProductAffinity.purchasePurchaseOccurrences. Likewise, the DoubleMeasurementHandler adds (or subtracts) the value from productAffinityFact.purchasePurchaseAffinity to (or from) aggregateProductAffinity.purchasePurchaseAffinity.

The measurement handlers for each warehouse affinity item descriptor in an exemplary embodiment include:

| Warehouse Item | Extract Item | Measurement Handlers |
|---|---|---|
| | | IntegerMeasurementHandler ( |
| | | “occurrences”, |
| | | “occurrences” ) |
| profilePurchaseProductFact | productPurchaseAffinity | TimestampMeasurementHandler ( |
| | | “lastPurchase”, |
| | | “lastPurchase” ) |
| | | IntegerMeasurementHandler ( |
| | | “occurrences”, |
| | | “occurrences” ) |
| profileCategoryPurchaseFact | categoryPurchaseAffinity | TimestampMeasurementHandler ( |
| | | “lastPurchase”, |
| | | “lastPurchase” ) |
| | | IntegerMeasurementHandler ( |
| | | “purchasePurchaseOccurrences”, |
| | | “purchasePurchaseOccurrences” ) |
| productAffinityFact | aggregateProductAffinity | DoubleMeasurementHandler ( |
| | | “purchasePurchaseAffinity”, |
| | | “purchasePurchaseAffinity” ) |
| | | AverageSpreadMeasurementHandler ( |
| | | “purchasePurchaseAffinity”, |
| | | “purchasePurchaseOccurences”, |
| | | “purchasePurchaseAverageSpread” ) |
| | | IntegerMeasurementHandler ( |
| | | “purchasePurchaseOccurrences”, |
| | | “purchasePurchaseOccurrences” ) |
| productAffinityGlobalFact | globalAggregateProductAffinity | DoubleMeasurementHandler ( |
| | | “purchasePurchaseAffinity”, |
| | | “purchasePurchaseAffinity” ) |
| | | AverageSpreadMeasurementHandler ( |
| | | “purchasePurchaseAffinity”, |
| | | “purchasePurchaseOccurrences”, |
| | | “purchasePurchaseAverageSpread” ) |
| | | IntegerMeasurementHandler ( |
| | | “purchasePurchaseOccurrences”, |
| | | “purchasePurchaseOccurrences” ) |
| categoryAffinityFact | aggregateCategoryAffinity | DoubleMeasurementHandler ( |
| | | “purchasePurchaseAffinity”, |
| | | “purchasePurchaseAffinity” ) |
| | | AverageSpreadMeasurementHandler ( |
| | | “purchasePurchaseAffinity”, |
| | | “purchasePurchaseOccurrences”, |
| | | “purchasePurchaseAverageSpread” ) |
| | | IntegerMeasurementHandler ( |
| | | “purchasePurchaseOccurrences”, |
| | | “purchasePurchaseOccurrences” ) |
| categoryAffinityGlobalFact | globalAggregateCategoryAffinity | DoubleMeasurementHandler ( |
| | | “purchasePurchaseAffinity”, |
| | | “purchasePurchaseAffinity” ) |
| | | AverageSpreadMeasurementHandler ( |
| | | “purchasePurchaseAffinity”, |
| | | “purchasePurchaseOccurrences”, |
| | | “purchasePurchaseAverageSpread” ) |
| | | MinMaxDoubleMeasurementHandler ( |
| | | “minPrice”, |
| | | “minPrice”, |
| | | true ) |
| profilePricePurchaseFact | priceAffinity | MinMaxDoubleMeasurementHandler ( |
| | | “maxPrice”, |
| | | “maxPrice”, |
| | | false ) |
| | | AverageAndStandardDeviationMeasurement |
| | | Handler ( |
| | | “avgPrice”, |
| | | “averagePrice”, |
| | | “occurrences”, |
| | | “occurrences”, |
| | | “standardDeviation”, |
| | | “standardDeviation”, |
| | | “minPrice”, |
| | | “maxPrice” ) |

The following specific preferred embodiments describe exemplary implementation details of a personal affinity engine and methods. The top N products, brands, and categories are tracked for each user. A merchant may wish to sort products (or brands, or categories) based on the quantity purchased, the last purchase date, and the average sale price. This data will be kept in the Data Warehouse Extract Repository, and will have the following repository item descriptors:

```
<item-descriptor name=“productPurchaseAffinity”>
  <table name=“profile_product_purchase_fact_summary”
  type=“primary”
      id-column-names=“profile_id,product_id”>
  <property name=“id” column-names=“profile_id,product_id”
      data-types=“string,string”/>
  <property name=“profile” column-name=“profile_id”
        data-type=“string” required=“true”/>
  <property name=“product” column-name=“product_id”
        item-type=“product”
        repository=“/atg/commerce/catalog/ProductCatalog”
        required=“true”/>
  <property name=“lastPurchase” column-name=“last_purchase”
        data-type=“timestamp” required=“true”/>
  <property name=“occurances” column-name=“occurrences”
        data-type=“integer”/>
  </table>
</item-descriptor>
<item-descriptor name=“brandPurchaseAffinity”>
  <table name=“profile_brand_purchase_fact_summary”
  type=“primary”
      id-column-names=“profile_id,brand_id”>
  <property name=“id” column-names=“profile_id,brand_id”
      data-types=“string,string”/>
    <property name=“profile” column-name=“profile_id”
        data-type=“string” required=“true”/>
    <property name=“brand” column-name=“brand_id”
        data-type=“string” required=“true”/>
    <property name=“lastPurchase” column-name=“last_purchase”
        data-type=“timestamp” required=“true”/>
    <property name=“occurances” column-name=“occurrences”
        data-type=“integer”/>
  </table>
</item-descriptor>
<item-descriptor name=“productBrowseAffinity”>
  <table name=“profile_product_browse_fact_summary”
  type=“primary”
      id-column-names=“profile_id,product_id”>
  <property name=“id” column-names=“profile_id,product_id”
      data-types=“string,string”/>
  <property name=“profile” column-name=“profile_id”
        data-type=“string” required=“true”/>
  <property name=“product” column-name=“product_id”
        item-type=“product”
        repository=“/atg/commerce/catalog/ProductCatalog”
        required=“true”/>
  <property name=“lastBrowse” column-name=“last_browse”
        data-type=“timestamp” required=“true”/>
  <property name=“occurrences” column-name=“occurrences”
        data-type=“integer”/>
  </table>
</item-descriptor>
<item-descriptor name=“categoryPurchaseAffinity”>
  <table name=“profile_category_purchase_fact_summary”
  type=“primary”
      id-column-names=“profile_id,category_id”>
    <property name=“id” column-names=“profile_id,category_id”
      data-types=“string,string”/>
    <property name=“profile” column-name=“profile_id”
        data-type=“string” required=“true”/>
    <property name=“category” column-name=“category_id”
        item-type=“category”
        repository=“/atg/commerce/catalog/ProductCatalog”
        required=“true”/>
    <property name=“lastPurchase” column-name=“last_purchase”
        data-type=“timestamp” required=“true”/>
    <property name=“occurrences” column-name=“occurrences”
        data-type=“integer”/>
  </table>
</item-descriptor>
```

This schema allows queries that return the users' most commonly purchased products, brands, and categories. It also allows queries that return users who most commonly buy a particular brand, category, or product.

In addition, aggregate affinity can be used by the present systems as described previously. In some preferred exemplary embodiments, there are N classes of aggregate affinity data. These include: Purchase to purchase affinity; Category to category affinity; Browse to purchase affinity; and Browse to browse affinity.

This data is maintained in the data warehouse, and will have the following repository item descriptors mapped:

```
<item-descriptor name=“aggregateProductAffinity”>
  <table name=“DCSX_PROD_AFF_FACT_SUM” type=“primary”
      id-column-names=“product_1_id,product_2_id,segment_name”>
    <property name=“id” column-names=“product_1_id,product_2_id,segment_name”
        data-types=“string,string,string”/>
    <property name=“product1” column-name=“product_1_id”
          item-type=“product”
          repository=“/atg/commerce/catalog/ProductCatalog”/>
    <property name=“product2” column-name=“product_2_id”
          item-type=“product”
          repository=“/atg/commerce/catalog/ProductCatalog”/>
    <property name=“segment” column-name=“segment_name” data-type=“string”/>
    <property name=“purchasePurchaseOccurrences”
        column-name=“purchase_purchase_occurrences”
        data-type=“integer”/>
    <property name=“purchasePurchaseAffinity”
        column-name=“purchase_purchase_affinity”
        data-type=“double”/>
    <property name=“purchasePurchaseAverageSpread”
        column-name=“purchase_purchase_avg_spread”
        data-type=“double”/>
    <property name=“browsePurchaseOccurrences”
        column-name=“browse_purchase_occurrences”
        data-type=“integer”/>
    <property name=“browsePurchaseAffinity”
        column-name=“browse_purchase_affinity”
        data-type=“double”/>
    <property name=“browseBrowseOccurrences”
        column-name=“browse_browse_occurrences”
        data-type=“integer”/>
    <property name=“browseBrowseAffinity”
        column-name=“browse_browse_affinity”
        data-type=“double”/>
  </table>
</item-descriptor>
<item-descriptor name=“aggregateCategoryAffinity”>
  <table name=“DCSX_CAT_AFF_FACT_SUM” type=“primary”
      id-column-names=“category_1_id,category_2_id,segment_name”>
    <property name=“id” column-names=“category_1_id,category_2_id,segment_name”
        data-types=“string,string,string”/>
    <property name=“category1” column-name=“category_1_id”
          item-type=“category”
          repository=“/atg/commerce/catalog/ProductCatalog”/>
    <property name=“category2” column-name=“category_2_id”
          item-type=“category”
          repository=“/atg/commerce/catalog/ProductCatalog”/>
    <property name=“segment” column-name=“segment_name” data-type=“string”/>
    <property name=“purchasePurchaseOccurrences”
        column-name=“purchase_purchase_occurrences”
        data-type=“integer”/>
    <property name=“purchasePurchaseAffinity”
        column-name=“purchase_purchase_affinity”
        data-type=“double”/>
    <property name=“purchasePurchaseAverageSpread”
        column-name=“purchase_purchase_avg_spread”
        data-type=“double”/>
  </table>
</item-descriptor>
<item-descriptor name=“globalAggregateProductAffinity”>
  <table name=“DCSX_PROD_AFF_GLOBAL_FACT_SUM” type=“primary”
      id-column-names=“product_1_id,product_2_id,segment_id”>
    <property name=“id” column-names=“product_1_id,product_2_id,segment_id”
        data-types=“string,string,string”/>
    <property name=“product1” column-name=“product_1_id”
          item-type=“product”
          repository=“/atg/commerce/catalog/ProductCatalog”/>
    <property name=“product2” column-name=“product_2_id”
          item-type=“product”
          repository=“/atg/commerce/catalog/ProductCatalog”/>
    <property name=“purchasePurchaseOccurrences”
        column-name=“purchase_purchase_occurrences”
        data-type=“integer”/>
    <property name=“purchasePurchaseAffinity”
        column-name=“purchase_purchase_affinity”
        data-type=“double”/>
    <property name=“purchasePurchaseAverageSpread”
        column-name=“purchase_purchase_avg_spread”
        data-type=“double”/>
    <property name=“browsePurchaseOccurrences”
        column-name=“browse_purchase_occurrences”
        data-type=“integer”/>
    <property name=“browsePurchaseAffinity”
        column-name=“browse_purchase_affinity”
        data-type=“double”/>
    <property name=“browseBrowseOccurrences”
        column-name=“browse_browse_occurrences”
        data-type=“integer”/>
    <property name=“browseBrowseAffinity”
        column-name=“browse_browse_affinity”
        data-type=“double”/>
  </table>
</item-descriptor>
<item-descriptor name=“globalAggregateCategoryAffinity”>
  <table name=“category_affinity_global_fact_summary” type=“primary”
      id-column-names=“category_1_id,category_2_id,segment_id”>
    <property name=“id” column-names=“category_1_id,category_2_id,segment_id”
        data-types=“string,string,string”/>
    <property name=“category1” column-name=“category_1_id”
          item-type=“category”
          repository=“/atg/commerce/catalog/ProductCatalog”/>
    <property name=“category2” column-name=“category_2_id”
          item-type=“category”
          repository=“/atg/commerce/catalog/ProductCatalog”/>
    <property name=“purchasePurchaseOccurrences”
        column-name=“purchase_purchase_occurrences”
        data-type=“integer”/>
    <property name=“purchasePurchaseAffinity”
        column-name=“purchase_purchase_affinity”
        data-type=“double”/>
    <property name=“purchasePurchaseAverageSpread”
        column-name=“purchase_purchase_avg_spread”
        data-type=“double”/>
  </table>
</item-descriptor>
```

For the present illustrative and preferred embodiments, an application programming interface (“API”) is used by the system. This interface allows for passage and proper inter-operability of more than one component with an internal or external object or component. These item descriptors are used by the globally-scoped AffinityService Nucleus component according to a preferred embodiment hereof, including the following exemplary methods and orderings:

List getProfilePurchases(String pProfileId, int pMaxItems)
Gets a List of product repository items, up to pMaxItems long, by finding the productPurchaseAffinity items whose profile matches the pProfileId, ordered by the number of occurrances, descending.

List getProfileBrands(String pProfileId, int pMaxItems)
Gets a List of String objects containing a brancd name, up to pMaxItems long, by finding the brandPurchaseAffinity whose profile matches the pProfileId, ordered by the number of occurrances, descending.

List getProfileCategories(String pProfileId, int pMaxItems)
Gets a List of category repository items, up to pMaxItems long, by finding the categoryPurchaseAffinity items whose profile matches the pProfileId, ordered by the number of occurrances, descending.

List getProfileBrowses(String pProfileId, int pMaxItems)
Gets a List of product repository items, up to pMaxItems long, by finding the productBrowseAffinity items whose profile matches the pProfileId, ordered by the number of occurrances, descending.

List getAggregateProductAffinity(String pProductId, String pSegment, SortDirective pSortDirective, int pMaxItems)
Gets a List of product repository items, up to pMaxItems long, by finding the aggregateProductAffinity items whose product and segment match pProductId and pSegment, ordered by the sort directive. The sort directive is one of the static values provided with the service.

AffinitySelling.SORT_PURCHASE_PURCHASE_AFFINITY.

List getGlobalAggregateProductAffinity(String pProductId, SortDirective pSortDirective, int pMaxItems)
Gets a List of product repository items, up to pMaxItems long, by finding the globalAggregateProductAffinity items whose product matches pProductId, ordered by the sort directive. The sort directive should be one of the static values provided with the service, for example AffinitySelling.SORT_PURCHASE_PURCHASE_AFFINITY.

List getAggregateCategoryAffinity(String pCategoryId, String pSegment, SortDirective pSortDirective, int pMaxItems)
Gets a List of category repository items, up to pMaxItems long, by finding the aggregateCategoryAffinity items whose category and segment match pCategoryId and pSegment, ordered by the sort directive. The sort directive should be one of the static values provided with the service, for example AffinitySelling.SORT_PURCHASE_PURCHASE_AFFINITY.

List getGlobalAggregateCategoryAffinity(String pCategoryId, SortDirective pSortDirective, int pMaxItems)
Gets a List of category repository items, up to pMaxItems long, by finding the globalAggregateCategoryAffinity items whose category matches pCategoryId, ordered by the sort directive. The sort directive should be one of the static values provided with the service, for example AffinitySelling.SORT_PURCHASE_PURCHASE_AFFINITY.

The sorting directives belong to the AffinitySelling class as static values, e.g.:
public static SortDirective SORT_PURCHASE_PURCHASE_AFFINITY=new SortDirective(“purchasePurchaseAffinity”, SortDirective.DIR_SORT_DESCENDING);
public static SortDirective SORT_PURCHASE_PURCHASE_OCCURRENCES=new SortDirective(“purchasePurchaseOccurrences”,

SortDirective.DIR_SORT_DESCENDING);
public static SortDirective SORT_PURCHASE_PURCHASE_AVERAGE_SPREAD=new SortDirective(“purchasePurchaseAverageSpread”,

SortDirective.DIR_SORT_DESCENDING);

Droplets extend from an abstract AffinityDroplet class, whose properties include dataWarehouseExtractRepository, a reference to the Data Warehouse Extract Repository component, affinityService, a reference to the affinity service, and defaultHowMany, which contains the default number of items to be returned by the AffinityService. AffinityDroplet includes the following methods in a preferred embodiment:

int getDefaultHowMany( )
Returns the value of the defaultHowMany property, or Integer.MAX_VALUE if it has not been explicitly set.

void service(DynamoHttpServletRequest pRequest, DynamoHttpServletResponse pResponse)
Gets affinity items from getaffinityItems, and puts them into the items output parameter, and services the output parameter. If an error occurs, service the error parameter instead.

int getHowMany(DynamoHttpServletRequest pRequest)
Gets the value of the howMany input parameter. If that parameter is not populated, get the value of the defaultHowMany property.

List getAffinityItems(DynamoHttpServletRequest pRequest)
Protected abstract method that subclasses override to return some repository items via the Data Warehouse Extract Repository.

The profile affinity droplets will be request scoped, and will have a property containing a reference to the profile component. These droplets include: ProfileProductAffinityDroplet; ProfileBrandAffinityDroplet; and ProfileCategoryAffinityDroplet.

In some embodiments, each of these items overrides the getaffinityItems method, returning product items, brand Strings, and category items from the productPurchaseAffinity, brandPurchaseAffinity, and categoryPurchaseAffinity items, respectively.

The aggregate affinity droplets are globally scoped, and can be used to determine the primary segment for the user, including: ProductProductAffinityDroplet; and CategoryCategoryAffinityDroplet.

Each of these items overrides the getaffinityItems method, returning product items from the aggregateProductAffinity or aggregateGlobalProductAffinity, or category items from the aggregateCategoryAffinity or aggregateGlobalCategoryAffinity, respectively. If the primary segment of the user can be determined (via the segment list manager), item from the the aggregateProductAffinity or aggregateCategoryAffinity are returned. Otherwise items from the aggregateGlobalProductAffinity or aggregateGlobalCategoryAffinity are returned.

These droplets will also have an additional method, that gets the value of a droplet parameter that will let the page developer get global affinity data, even if the primary segment of the user is known.

The present disclosure is not intended to be limited by its preferred embodiments, and other embodiments are also comprehended and within its scope. Numerous other embodiments, modifications and extensions to the present disclosure are intended to be covered by the scope of the present inventions as claimed below. This includes implementation details and features that would be apparent to those skilled in the art.

What is claimed is:

1. A system for providing purchasing recommendations to a customer, comprising:
a customer interface for sending and receiving information to and from said customer;
a storage medium for storing data relating to said products;
a processor for processing data relating to said customer and said products;
said processor determining an affinity between at least one product and another product group wherein said product group comprises at least one other product.

2. The system of claim 1, further comprising a closed-loop arrangement of said customer interface, said storage medium, and said processor so that said recommendations may be made to the customer without real-time intervention by a marketer.

3. The system of claim 1, wherein said processor is part of an affinity engine that performs affinity-based analyses using said data relating to said products and said data relating to said customer as inputs and provides information corresponding to said purchasing recommendations as an output.

4. The system of claim 1, further comprising a rules-based analyzer for executing pre-programmed rules to determine said purchasing recommendations.

5. The system of claim 1, further comprising a statistical analyzer for analyzing data stored within said storage medium.

6. The system of claim 1, further comprising a data structure stored within said storage medium, said data structure containing a product tree describing attributes of said products and product groups.

7. The system of claim 1, further comprising a comparator for comparing a calculated affinity with a reference affinity of a reference pair of products.

8. The system of claim 1, further comprising a configuration module for configuring an aspect of the operation of the system and subsequently affecting the purchase recommendations of the system.

9. The system of claim 1, further comprising a report generator that generates a report relating to a performance measure of said system.

10. The system of claim 1, further comprising a search module permitting the customer to search for product information stored in said storage medium.

11. A method for providing purchase recommendations to a customer, comprising:
receiving information from said customer through a customer interface;
determining a first affinity score corresponding to said received information and information stored on a storage medium containing product data;
determining whether to make a purchase recommendation to the customer based on the first affinity score;
if said affinity score does not meet a preset threshold condition, determining a second affinity score corresponding to said received information and information stored on the storage medium.

12. The method of claim 11, further comprising comparing any of said first and second affinity scores to a reference affinity score representing an affinity of a reference pair.

13. The method of claim 11, further comprising providing an output to said customer representative of a purchase recommendation for a product.

14. The method of claim 11, further comprising segmenting a plurality of products available for purchase into a plurality of product segments, each of which contains at least one product from the plurality of products available for purchase.

15. The method of claim 11, said steps of determining an affinity score comprising executing instruction corresponding to a rule from a pre-programmed set of rules.

16. The method of claim 11, said steps of determining an affinity score comprising executing instructions corresponding to a statistical analysis of data stored on said storage medium.

17. The method of claim 11, further comprising ordering a plurality of purchase recommendations in an order determined by one of said affinity scoring steps.

18. The method of claim 11, said first affinity scoring step comprising a product-to-product affinity calculation and said second affinity scoring step comprises at least a segment as part of a pairing for which said second affinity scoring step is determined.

19. The method of claim 11, said first affinity scoring comprising scoring on the basis of price affinity.

20. The method of claim 11, said first affinity scoring comprising scoring on the basis of a brand of a product offered for purchase.

21. The method of claim 11, further comprising configuring an aspect of the affinity scoring steps.

22. The method of claim 11, further comprising generating a report relating to a performance measure of an affinity-based commerce system.

23. The method of claim 11, said first affinity score being calculated at least based on a customer segment affinity.

24. The method of claim 11, said first affinity score being calculated at least based on a temporal time spread between an occurrence of a first event and an occurrence of a second event.

25. The method of claim 24, further comprising adjusting said first affinity score based on said temporal time spread.

26. The method of claim 25, further comprising calculating a decay factor by which said first affinity score is adjusted, said first affinity score being reduced as said temporal time spread increases.

27. The method of claim 11, said first affinity score being calculated at least based on an age of said stored information.

28. The method of claim 27, further comprising adjusting said first affinity score based on said age of said stored information.

29. The method of claim 28, further comprising calculating a decay factor by which said first affinity score is adjusted, said first affinity score being reduced as said age of said stored information increases.

30. A computer-readable medium accessible to an online retailing system, comprising:
computer-readable instructions enabling the receipt of customer information from a customer information interface;
computer-readable instructions enabling the access of stored product information;
computer-readable instructions enabling an affinity processor to take said customer information and said stored product information and determine an output corresponding to an affinity relating to one or more of said stored product information; and
computer-readable instructions enabling said online retailing system to make a purchase recommendation to said customer.

31. The computer-readable medium of claim 30, further comprising computer-readable instructions enabling computation of a decay function describing a reduction in said affinity as a function of a length of time elapsed between a first and second event relating to said stored product information.
